(19) United States
(12) Patent Application Publication
(10) Pub. No.: US 2026/0135919 A1
(43) Pub. Date: May 14, 2026

(54) MACHINE-LEARNING TECHNIQUES FOR FAMILY PROFILE MANAGEMENT

(71) Applicant: PANASONIC WELL LLC, Palo Alto, CA (US)

(72) Inventors: Yoky Matsuoka, Los Altos Hills, CA (US); David Justus, Brooklyn, NY (US); Sandy Anuras, Seattle, WA (US); Katlyn Bren Johnson, Palo Alto, CA (US); Mary Christine Virginia Baynham Pitts, Palo Alto, CA (US); Anisha Kharkia, Palo Alto, CA (US); Dipti Rai, Pleasanton, CA (US)

(21) Appl. No.: 19/340,617

(22) Filed: Sep. 25, 2025

Related U.S. Application Data
(60) Provisional application No. 63/720,620, filed on Nov. 14, 2024.

(51) Int. Cl. H04L 67/306; G06F 9/451; G06F 11/34; G06N 5/022

(52) U.S. Cl. CPC H04L 67/306; G06F 9/451; G06F 11/3447; G06N 5/022

(57) ABSTRACT

Techniques for artificial intelligence systems to provide customized services, tasks, and recommendations to related user devices based on data streams. In an example, a method may obtain one or more data streams received during one or more ongoing communications sessions among a set of users and an automated agent, wherein the one or more data streams are converted by one or more large language models (LLMs) into a set of key-value pairs of user attributes, wherein the set of key-value pairs are used to generate merged attributes corresponding to the set of users, and wherein the merged attributes are used to update a set of profiles. A method may update one or more user interfaces associated with a user of the set of users to facilitate the one or more ongoing communications sessions using the merged attributes.

### CROSS-REFERENCE TO RELATED APPLICATIONS

The present application claims the benefit of U.S. Provisional Application 63/720,620 filed Nov. 14, 2024 and is related to U.S. Non-Provisional Application entitled “SYSTEMS AND METHODS FOR PROACTIVE ARTIFICIAL INTELLIGENCE” filed Sep. 25, 2025 (Attorney Docket No.: 109304-847304-008700US), U.S. Non-Provisional Application entitled “SYSTEMS AND METHODS FOR DYNAMIC CONVERSATIONAL INTERFACES ACCORDING TO DETECTED USER BEHAVIORS” filed Sep. 25, 2025 (Attorney Docket No.: 109304-847284-009300US) and U.S. Non-Provisional Application entitled “SYSTEMS AND METHODS FOR AUTOMATED USER RELATIONSHIP PROFILING” filed Sep. 25, 2025 (Attorney Docket No.: 109304-847283-009500US), each of which are incorporated herein by reference in their entireties and for all purposes.

### FIELD

The present disclosure generally relates to artificial intelligence systems. More specifically, and without limitation, the present disclosure relates to using artificial intelligence systems to provide customized services, tasks, and recommendations to related user devices based on data streams.

### SUMMARY

The systems and methods disclosed herein use artificial intelligence systems to automatically and continuously process data streams associated with a set of related users to extract data usable to provide customized services, tasks, and recommendations to related user devices based on extracted information from the data streams.

In some aspects, the techniques described herein relate to a computer-implemented method, the method including: obtaining one or more data streams received during one or more ongoing communications sessions among a set of users and an automated agent, wherein the one or more data streams are converted by one or more large language models (LLMs) into a set of key-value pairs of user attributes, wherein the set of key-value pairs are used to generate merged attributes corresponding to the set of users, and wherein the merged attributes are used to update a set of profiles; updating one or more user interfaces associated with a user of the set of users to facilitate the one or more ongoing communications sessions using the merged attributes; receiving one or more tasks associated with the set of users, wherein the one or more tasks improve metrics associated with the set of users, and wherein the one or more tasks are generated by analyzing the set of profiles with a trained machine learning algorithm; accessing feedback for the one or more tasks, wherein the feedback is used to update the merged attributes and the metrics; monitoring, based on the one or more data streams, real-time performance associated with the one or more tasks; and updating, based on the real-time performance associated with the one or more tasks, the one or more user interfaces and the set of profiles.

In some aspects, the techniques described herein relate to a system, including: one or more processors; and memory storing thereon instructions that, as a result of being executed by the one or more processors, cause the system to: obtain one or more data streams received during one or more ongoing communications sessions among a set of users and an automated agent, wherein the one or more data streams are converted by one or more large language models (LLMs) into a set of key-value pairs of user attributes, wherein the set of key-value pairs are used to generate merged attributes corresponding to the set of users, and wherein the merged attributes are used to update a set of profiles; update one or more user interfaces associated with a user of the set of users to facilitate the one or more ongoing communications sessions using the merged attributes; receive one or more tasks associated with the set of users, wherein the one or more tasks improve metrics associated with the set of users, and wherein the one or more tasks are generated by analyzing the set of profiles with a trained machine learning algorithm; access feedback for the one or more tasks, wherein the feedback is used to update the merged attributes and the metrics; monitor, based on the one or more data streams, real-time performance associated with the one or more tasks; and update, based on the real-time performance associated with the one or more tasks, the one or more user interfaces and the set of profiles.

In some aspects, the techniques described herein relate to a non-transitory computer-readable storage medium storing thereon executable instructions that, as a result of being executed by one or more processors of a computer system, cause the computer system to: obtain one or more data streams received during one or more ongoing communications sessions among a set of users and an automated agent, wherein the one or more data streams are converted by one or more large language models (LLMs) into a set of key-value pairs of user attributes, wherein the set of key-value pairs are used to generate merged attributes corresponding to the set of users, and wherein the merged attributes are used to update a set of profiles; update one or more user interfaces associated with a user of the set of users to facilitate the one or more ongoing communications sessions using the merged attributes; receive one or more tasks associated with the set of users, wherein the one or more tasks improve metrics associated with the set of users, and wherein the one or more tasks are generated by analyzing the set of profiles with a trained machine learning algorithm; access feedback for the one or more tasks, wherein the feedback is used to update the merged attributes and the metrics; monitor, based on the one or more data streams, real-time performance associated with the one or more tasks; and update, based on the real-time performance associated with the one or more tasks, the one or more user interfaces and the set of profiles.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

FIG. 1 is a diagram depicting an exemplary system of devices interacting with a system including a family profile, in accordance with various embodiments.

FIG. 2 is a block diagram of a system for conversion of data streams to family goals, in accordance with various embodiments.

FIG. 3 is a block diagram of an example of a system for extraction of attributes based on data streams related to a user by a wellness system in accordance with various embodiments.

FIG. 4 is a diagram of a system for raw data extraction for creation of a family profile, in accordance with various embodiments.

FIG. 5 is a diagram of a system for a creation of a family profile, in accordance with various embodiments.

FIG. 6 is a flowchart depicting an exemplary process for using artificial intelligence systems to provide services to user systems, in accordance with various embodiments.

FIG. 7 illustrates an example user interface for an example mobile application for interacting with a family profile, in accordance with various embodiments.

FIG. 8 illustrates an example user interface for an example mobile application for interacting with a family profile, in accordance with various embodiments.

FIG. 9 illustrates an example user interface for an example mobile application for interacting with a family profile, in accordance with various embodiments.

FIG. 10 illustrates an example user interface for an example mobile application for interacting with a family profile, in accordance with various embodiments.

FIG. 11 illustrates an example user interface for an example mobile application for interacting with a family profile, in accordance with various embodiments.

FIG. 12 illustrates an example user interface for an example mobile application for interacting with a family profile, in accordance with various embodiments.

FIG. 13 illustrates an example user interface for an example mobile application for interacting with a family profile, in accordance with various embodiments.

FIG. 14 illustrates a computing system architecture, including various components in electrical communication with each other, in accordance with some embodiments.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide an artificial intelligence framework to automatically and continuously evaluate family and/or user data extracted from various data streams to identify and recommend tasks or goals to one or more users to reduce the user's cognitive load. Through this framework, the systems and methods disclosed herein can monitor data streams associated with one or more users to automatically identify possible tasks that can be performed for the benefit of the users or set of users. Further, the artificial intelligence system can automatically identify any additional information that may be required for the creation and execution of these tasks or goals. Once these tasks have been created, the artificial intelligence system can coordinate with individual users, the set of users, an AI agent, and/or third-party services to perform these tasks for the benefit of the individual users and/or the set of users.

Certain aspects relate to using artificial intelligence techniques to automatically and continuously process data streams associated with a set of related users to extract data usable to provide customized services, tasks, and recommendations to related user devices based on extracted information from the data streams. In an example, the artificial intelligence system includes a wellness system that facilitates assisting busy families in managing their schedules, activities, and family goals. For instance, the wellness system may create, update, and delete family events based on communications within a chat interface, providing seamless event management and reducing time spent navigating multiple screens. In some examples, the wellness system may generate events, goals, recommendations, and/or tasks based on data streams related to a user or set of users. Certain aspects may be implemented by or supported by a mobile application (“application”) that is connected to an artificial intelligence system.

The following non-limiting example is introduced for illustrative purposes. A first user opens an application that is connected to an artificial intelligence system. The artificial intelligence system may include one or more machine learning models, such as a large language models, which build and update a family profile based on data extracted from data streams related to a set of users. As explained below, a family profile may store information related to users and families. Users can interact with an automated AI agent provided by the artificial intelligence system (e.g., wellness system) and perform functions by using the agent, for example, by providing instructions or selecting from one or more options provided by the agent.

A family profile may be leveraged by one or more features executing locally on an application and/or executing one or more different cloud-based services, e.g., hosted on servers. In some cases, one or more services are hosted on remote or third-party servers. As explained below, the services discussed herein can access and/or update a family profile to make various recommendations on a variety of activities such as tasks or goals that a user or set of users (e.g., a family) may act upon. A given user may have all of or a subset of the activities at any given time.

In some examples, an application provides an intelligent, contextual family wellness coach (e.g., automated intelligence system, AI agent, etc.) via one or more user interfaces for improving family well-being. The AI agent facilitates setting shared and individual family member goals. For example, the AI agent asks family members to plan, act, and/or reflect on activities that may help the members reach their wellness goals. The AI agent provides an interactive, continuously learning experience to identify and prioritize family goals for well-being including, but not limited to food and nutrition, activity and fitness, quality family time, personal time, and so forth.

The automated intelligence system may be built around the family and individual family members and can provide wellness coaching to family members resulting in enhanced connections with each other, family bonding, and more. The automated intelligence system may collect family members experiences and enriches the family profile to enhance context and family member specific coaching. The automated intelligence system may streamline coordination across the family including enabling collaboration to achieve shared and individual goals, ideas to further enhance ability to achieve goals (e.g., meal night, game night, family nights, facilitating the addition of specific activities to the family's routine, and more). The automated intelligence system can provides improved care for family members. Family members can share areas where they need help (e.g., balancing stress, being present for their family, efficiently scheduling events, etc.). The automated intelligence system can facilitate multi-modal interactions with experts and/or other third parties who can provide recommendations/services to address family member concerns (e.g., commit to a certain number of mins of daily physical activity, take time to reflect daily with thought guidance, block out focused time for uninterrupted connection, manage nutrition, etc.).

The automated intelligence system provides conversational family profile building and the ability to interpret data from real-time data streams, such as conversations between family members. A family leader or administrator can monitor and investigate the activities of family members including obtaining alerts and metrics regarding key well-being indicators. Family members can see content specifically relevant to them. Views are dynamically created and updated based on the data provided by the automated intelligence system and/or inferences based on the data being gathered.

One or more user interfaces may be dynamically updated with specific information for individual users and relevant goals or tasks to achieve a well-being objective. Family members can request assistance with tasks. They can request guidance on how to accomplish a task (e.g., prepare a meal), request assistance from a family member (e.g., request a relative to purchase the grocery items required for preparing the meal), and so forth.

As discussed, certain aspects use machine learning. For example, certain aspects may use large language models. As described herein, the machine-learning model can be a multimodal model that includes a natural-language processing model trained using the previous input data (e.g., the multimodal data) and corresponding device configurations associated with the previous input data. In some instances, the natural-language model is a transformer model (e.g., a large-language model (LLM)) obtained from a models database. In some instances, the machine-learning model is trained using self-supervised learning based on a large corpus of text data, such that the machine-learning model can generate the model-generated narrative content. In addition to training the model, various prompts can be used for prompt engineering of the machine-learning model for generating the model-generated narrative content. Examples of the content machine-learning model can include, but are not limited to, BERT model, Claude LLM, Falcon 40B, Ernie, GPT-3, GPT-3.5, GPT 4, Lamda, and Llama.

In some instances, the machine-learning model can be generated based on different types of machine-learning architectures. An example architecture used for transformer models can include a transformer model that includes an encoder and a decoder. Another example can include a Bidirectional Encoder Representations from Transformers (BERT), which is configured to understand the context of a word in search queries by considering the words on both its left and right.

In yet another example, a machine-learning architecture can include a Generative Pre-trained Transformer (GPT) that is trained using autoregressive language modeling and masked self-attention techniques. For example, the masked self-attention techniques can include masking future tokens when generating a contextual representation representing a given token, such that the contextual representation is determined only based on past tokens. The autoregressive language modeling techniques can then predict the next token of an output sequence based on the contextual representations of the text tokens.

Other examples of machine-learning architectures can include: (1) a Text-to-Text Transfer Transformer (T5) that converts all natural-language processing tasks into a text-to-text format, unifying various tasks under a single model architecture; and (2) a Vision Transformer (ViT) that extends the transformer architecture to process longer text sequences and image data, respectively, thereby facilitating the corresponding model to be used across different domains.

An illustrative example process of training the transformer model (e.g., a GPT model) is as follows. For the training dataset (e.g., the previous input data and corresponding model-generated narrative content), the masked self-attention process can begin by transforming each word in a given training text sequence into three vectors: the query (Q), key (K), and value (V) vectors. A Q vector can represent what information the token is querying about other tokens, a K vector can represent the token's context used to establish relationships with other tokens, and a V vector can represent the token's actual content/information. In some instances, the Q, K, and V vectors can be obtained by multiplying the input embeddings by learned weight matrices.

An attention score for a particular word can be calculated by taking the dot product of the Q vector of the word with the K vectors of all words in the sequence, thereby producing a score that reflects the relevance of each word pair. The attention scores can be used as weights, which can be applied to the Q, K, V vectors to generate a weighted contextual representation of the particular word. Stated differently, the attention score can be used as a weight to transform the Q, K, V vectors of a given word to generate a weighted, computed representation that can be used to train the corresponding transformer model.

In some instances, a mask can be applied to the self-attention mechanism such that a contextual representation of a given token is determined without weights associated with future tokens. As a result, an attention score of a particular token can be adjusted to disregard information from tokens that have not been processed yet. The attention scores can then be scaled by the square root of the key dimension to stabilize training and passed through a softmax function to convert the attention scores into probabilities, ensuring they sum to one. The transformation can identify the most relevant words while downplaying less important ones. The resulting attention weights can then be used to compute a weighted sum of the V vectors, thus producing a new contextual representation for each token that incorporates contextual information from the entire sequence.

To enhance the model's ability to capture various types of relationships, self-attention mechanisms can use multiple sets of Q, K, and V matrices, also referred to as multi-head attention. Each set, or head, can learn different aspects of the relationships within the input data. The outputs from these heads can be concatenated and linearly transformed to form the final self-attention output. This multi-head approach allows the transformer models to simultaneously consider different features and interactions, enriching its understanding of the input sequence.

The transformer model can then be trained using autoregressive language modeling to predict a subsequent token of a target sequence based on the contextual representations that represent the preceding tokens. For each position in the sequence, the transformer model accesses a contextual representation of the token, which was generated using masked self-attention mechanism. The transformer model can then output a probability distribution over a vocabulary for the subsequent token, conditioned on the sequence of preceding tokens. The subsequent token can then be compared with a corresponding token of the training data to calculate a loss. The loss measures the discrepancy between the predicted token and the actual token, providing a signal for the model to adjust its parameters. The loss can then be used to adjust parameters of the transformer model, including the parameters of the Q, K, V matrices.

Through iterative training iterations, the transformer model learns to minimize this loss across the entire training dataset. This process ensures that the model generates coherent and contextually appropriate sequences by leveraging the learned representations and adjusting its parameters based on the training data.

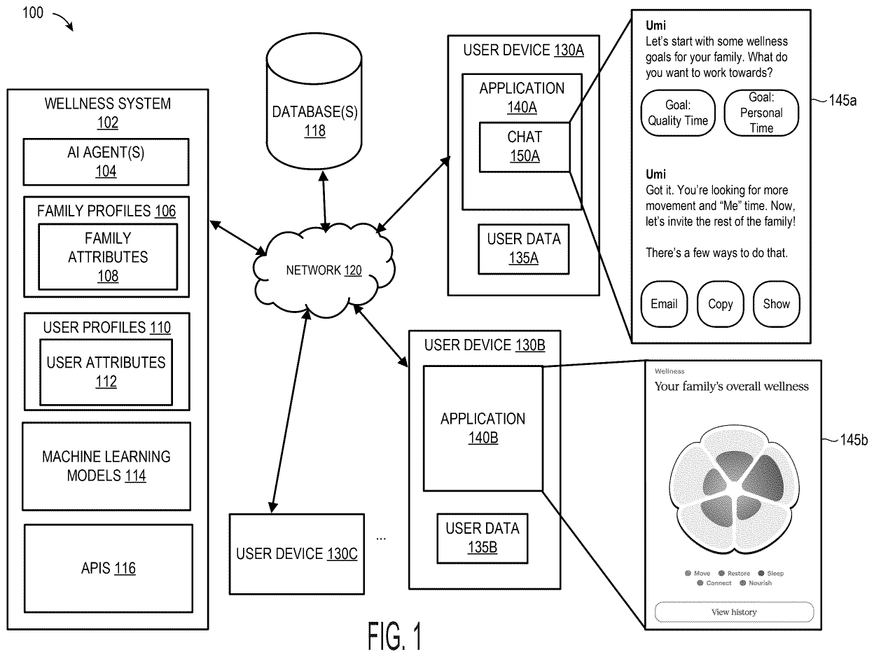

Turning now to the figures, FIG. 1 is a diagram depicting an exemplary system of devices interacting with a system including a family profile, in accordance with various embodiments. Example environment 100 includes a wellness system 102 configured to dynamically processes data streams from user devices 130a, 130b, . . . 130n. The wellness system 102 may include an AI agent 104, family profiles 106 including family attributes 108, user profiles 110 including user attributes 112, machine-learning models 114, and APIs 116. The wellness system 102 may store one or more family profiles 106, each family profile 106 associated with one or more users or sets of users (e.g., user devices 130a, 130b, . . . 130n). In some examples, the family profiles 106, user profiles 110, and/or machine learning models 114 may be stored in one or more databases 118 external to the wellness system 102. The wellness system 102 may communicate with user devices 130a, 130b, . . . 130n (which may be referred to, collectively, as a set of user devices) via network 120.

User devices 130a, 130b, . . . 130n may be associated with users and include user data 135a, 135b, . . . 130n, an application 140a, 140b, . . . 140n, and one or more user interfaces 145a, 145b, . . . 145n for interacting with the application 140a, with the wellness system 102, and/or with the other user devices 130b . . . 130n. A user may be authenticated at a user device 130a to access an application 140a at the user device 130a. The application 140a of the user device 130a may include a variety of interfaces for different features available to users, such as for inputting goals, for viewing metrics, for mood check-ins, for inputting likes/dislikes, for inputting activities, for managing users and/or the application 140a, for interacting with the AI agent 104, for interacting with other users (e.g., chat 150a), etc. For example, chat interface 145a enables a conversation among users and/or the agent AI 104, and wellness interface 145b includes a display overall wellness for a family. In some examples, a calendar interface may be provided to the set of users for managing family events and/or individual user events.

The wellness system 102 monitors user data 135a, 135b, etc. and/or data stream(s) associated with user devices 130a, 130b, etc., to extract user attributes 112 and/or family attributes that are used to define user profiles 110, a family profile 106, goals, individual and/or family tasks based on goals, etc. Attributes may be demographic information, relationship information, requirements, preferences, etc. for individuals and/or for the set of users that is extracted from one or more data streams. The attributes may be explicit (e.g., a user inputs relationship information), inferred (e.g., a user types in a chat to another user, “Hey, mom”), or a combination thereof (e.g., a user types “Hey, mom” and the agent AI asks the user, “Can you confirm that Kate [a second user in the chat] is your mother?”). User attributes 112 may be attributes specific to a user, family attributes 108 may be merged user attributes or attributes which are related to the family or set of users. The attributes may be stored as key-value datasets for individual users or for the set of users in a user profile 110 or in a family profile 106.

The wellness system 102 continuously updates the family profile 106 based on the data streams. The data streams may be converted and stored in the user profiles 110 of the wellness system 102 as user attributes 112. The user attributes 112 may be merged with other user attributes as family attributes 108 which are included in the family profiles 106 and described further below.

The data streams may be one or more real-time data streams associated with a user profile 110 and/or family profile 106. The one or more real-time data streams may be received from varying (i.e., disparate) sources. For example, the one or more real-time data streams may include be received from IoT devices, wearable devices, sensors (e.g., thermometers,, accelerometers, etc.), cameras, microphones, mobile devices (e.g., such as a smartphone, tablet, etc.), personal computing devices (e.g., computers, databases, servers, etc. operated by or associated with the one or more related users), websites or web services associated with the one or more related users, communication sessions of the wellness system 102 (e.g., such as communications between the one or more users and an AI agent 104, communications between the one or more user devices 130a and a terminal device, etc.), combinations thereof, and/or the like.

In some instances, the wellness system 102 may also receive information from one or more non-real-time data streams. The one or more non-real-time data streams may include information retrieved at regular or irregular intervals. For example, the data streams may include user data 135a that has been previously retrieved from devices connected to the user device 130a, such as wearable devices, tablets, etc.), and/or from data recorded by the user device 130a (e.g., locations visited, steps taken, sleep schedule, calendar data, events, images, e-mail messages, text messages, data from other applications, etc.), as non-limiting examples.

The wellness system 102 may define a dataset from the one or more real-time data streams. The dataset may correspond to a portion of data from the one or more real-time data streams. In some instances, the wellness system 102 may sample the real-time data stream according to a time window. The time window may be defined based on the family profile, user input, the one or more machine-learning models 114 of the wellness system 102, an identification of the one or more real-time data streams, data types of the one or more real-time data streams, a time of day, a quantity or frequency of data received over the one or more real-time data streams, combinations thereof, and/or the like. The family profile 106 may store information received from the set of users and information associated with the one or more users (e.g., received by the wellness system 102, derived by the wellness system 102, and/or the like). The family profile 106 may provide historical information associated with each of the users, the set of users, AI agent(s), and/or the wellness system 102. Examples include a quantity of data received by the wellness system 102, types of data received, a time over which particular data or data types are received by the wellness system 102, etc. For example, the wellness system 102 may use the family profile 106 to define a size of the window to sample the one or more real-time data streams based on when particular data or data types are likely to be included in the one or more real-time data streams (e.g., such as when particular calendar data, sensor data, IoT data, etc. is likely to be included in the one or more real-time data streams, etc.).

In some instances, the time window may be defined based a time interval associated with the one or more related users such as time after the one or more related users wake up, when the one or more related users return home, when the one or more related users go to sleep, etc. For example, the time window may be defined to sample a portion of the one or more real-time data streams corresponding to when the one or more related users are home and awake (e.g., increasing a likelihood that the data of the one or more real-time data streams correspond to user activities, etc.). Alternatively, or additionally, the window may be defined using data of the one or more real-time data streams (e.g., such as sensor data indicative of a user presence, user activity, etc.).

In some instances, the wellness system 102 may sample the one or more real-time data streams based on the data received by each real-time data stream. The wellness system 102 may define a different window for each real-time data stream based on any of the aforementioned factors. For instance, the wellness system 102 may sample a thermometer sensor using a small window, because a temperature of a user environment is unlikely to experience rapid changes in temperature and few data points are needed to by the wellness system 102. A work calendar may be sampled using a larger window to capture more information about the user, user availability, and changes to the calendar.

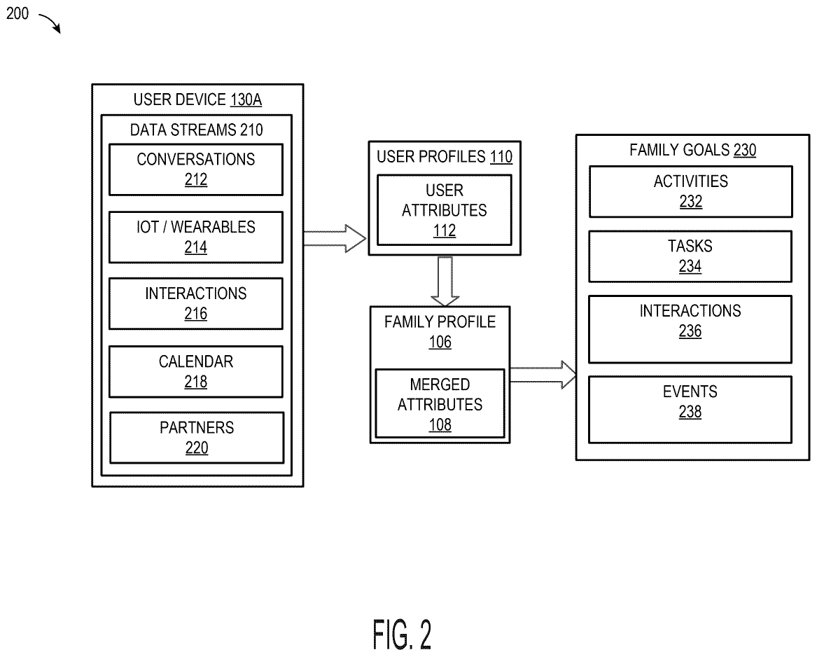

The wellness system 102 may include one or more AI agents 104 associated with the wellness system 102 and assigned to a user, a family, a task, a communications session, etc., to communicate with the users and/or serve as the interface to the wellness system 102. The AI agent 104, in some instances, is dynamically trained to automatically identify and address user intents obtained from user data, which will be described in further detail below with regards to FIG. 2. Further, the AI agent 104 may be dynamically trained to prompt for and obtain different user attributes associated with different users (e.g., user device 130a, 130b, 130c, . . . etc.) to update corresponding user profiles, family profiles, and/or define relationships among profiles. As described in greater detail herein, the user profiles, corresponding relationships, and user data may be used to dynamically generate tasks that may be performed to achieve indicated family goals and/or increase family metrics based on family goals. The AI agent 104 may further generate customized responses to user conversations and/or user interactions with each other and/or with the AI agent 104 according to any applicable constraints. These customized responses may be generated according to known responses maintained by the wellness system 102 and/or to different data sources from which the wellness system 102 may derive these customized responses according to the corresponding intents obtained from the user attributes 112 and/or family attributes 108.

In some examples, when a user (such as a parent, leader of a group, head of a family profile, etc.) accesses the wellness system 102 for the first time, the wellness system 102 may implement and assign an AI agent 104 to the user and to initiate an onboarding process for the user and the family profile 106 itself. In some other examples, the AI agent 104 may participate in a conversation among different users and provide prompts or responses within the conversation among the users and the AI agent 104. When a new communications session is established between a user device 130a and an AI agent 104, the AI agent 104 may automatically prompt the user a user interface to provide identifying information associated with the user and any other related users. For instance, when the user first engages the AI agent 104 through a new communications session, the AI agent 104 may determine whether there is an existing relationship between the user and other users of the wellness system 102. As an illustrative example, the AI agent 104 may prompt user to provide detailed information with regard to the composition of the user's family or related users (e.g., number of inhabitants in the member's home, the number of children in the member's home, the number and types of pets in the member's home, etc.), the physical location of the member's home, any special needs or requirements of the user or related users (e.g., physical or emotional disabilities, etc.), and the like. In some instances, the user may be prompted to provide demographic information (e.g., age, ethnicity, race, languages written/spoken, etc.). The user may also be prompted to indicate any personal goals that may be used to identify possible projects and tasks that may be performed in order to achieve these goals, as described in greater detail herein.

In some examples, the wellness system 102 provides an application or web service through which users (via user devices 130a, 130b, . . . 130n) may access an interface for initiating and engaging in communications sessions with automated AI agents 104 to address different user intents. For example, the wellness system 102 may provide, to a user device 130a, an application 140a that may be installed and executed from the user's device 130a to access, through the interface, the wellness system 102. Additionally, or alternatively, a user, through a browser application installed and executed from the user's device 130a, may access a website associated with the wellness system 102 and through which the wellness system 102 implements a web service that includes the interface. In some instances, to access the interface (either through an application executing on a computing device or through a web service), the user may be required to provide a set of credentials (e.g., username/password, a cryptographic key or token, biometric information, etc.) that may be used to authenticate and identify the user. For example, when the user executes the application or accesses the web service to initiate a new communications session through the wellness system 102, the wellness system 102 may prompt the user to provide a set of credentials associated with the user.

In response to receiving the set of credentials associated with the user, the wellness system 102 may process the set of credentials to determine whether the set of credentials is valid. For instance, in response to receiving a set of credentials from a user, the wellness system 102 may query the user profiles 110 to determine whether the provided set of credentials is associated with an existing user profile maintained by the wellness system 102. If the wellness system 102 determines that the provided set of credentials is not associated with an existing user profile, or that the provided set of credentials is not valid (e.g., the set of credentials does not match a known set of credentials maintained in an identified user profile, the set of credentials is expired, the set of credentials are flagged as being compromised, etc.), the wellness system 102 may reject the request from the user to initiate a communications session with an AI agent 104. If the wellness system 102 determines that the set of credentials is valid or otherwise that the user has been successfully authenticated, the wellness system 102 may establish a new communications session between the user and an AI agent 104.

The wellness system 102 may be implemented to reduce the cognitive load of members and their families by identifying different family goals and generating tasks that may be performed by different users and/or delegated to other entities (e.g., automated AI agents 104, human representatives associated with the wellness system, partners (e.g., third-party services, etc.), etc.) for performance on behalf of these families. For instance, as described in greater detail herein, if a user associated with user device 130a expresses a desire to engage in more activities together (e.g. in a conversation, by inputting the information into the application 140a, etc.), the AI agent 104 (or an agent specifically dedicated to the particular user, the particular task, the particular goal, etc.) may ask the user (in a separate conversation, a group conversation, a different interface, etc.), for additional details regarding the expressed desire (e.g. type of activity, a preferred time, a preferred day, etc.). In some examples, the AI agent 104 may check the user profile 110 and determine that the user likes to play games on weekends, and the AI agent 104 may suggest creating a game night on a weekend night where all users are available. The AI agent 104 may provide the suggestion to the user, the user may confirm the suggested date, time, and/or game or may provide modifications, such as a different date, time, or different game. Once the AI agent 104 has obtained feedback from the user, the AI agent 104 may create a calendar event for the users to be provided to the user devices 130a, 130b, . . . 130n. The calendars of each of the user devices 130a, 130b, etc. may be updated with the calendar event. In some other examples, the wellness system 102 may create a calendar event for a period of time each day for family communications, training for an event, spending time together, for an activity, etc.

In some examples, a user may initiate voting within a chat among the users and the AI agent 104. For example, a user may provide a subject for voting (e.g. a new family goal). The user may provide options to be presented to the family members via a chat interface, a special voting interface, etc. The user may provide a time window for responding (e.g., one hour, 12 hours, a day, two days, a week, etc. In some examples, the window for responding may be based on number of votes cast (e.g., once 75% of the family members votes have been cast). In some examples, the user may delegate the voting to the AI agent by requesting that the AI agent start a vote for the members of the family and indicate to the AI agent all relevant parameters. The AI agent 104 may prompt the user for any missed parameters and/or additional parameters, and the AI agent 104 may present the voting information to the user for a final review before initiating the voting process. In some examples, the AI agent 104 may automatically begin the voting process without a final review. In some examples, the AI agent may suggest additional options or recommendations when the voting process is being created, which may be based on user attributes and/or family attributes in the various profiles.

In some examples, as the user submits a response to a prompt provided by the AI agent 104, the response is automatically transmitted to the wellness system 102 to dynamically extract any inferred attributes that may be used to define one or more user attributes 112 for the user and/or any other related users. The wellness system 102 may employ natural language processing (NLP) or any other language parsing algorithm or executable code to automatically parse the response. Through this parsing of the response, the wellness system 102 may identify particular terms or phrases that may be used to determine different attributes associated with the users, other users, or the family/set of users.

In some examples, the wellness system 102 dynamically trains and implements one or more large language models (LLM) and/or other generative artificial intelligence processes to evaluate the extracted terms or phrases from the provided response, identify one or more attributes that may be assigned to one or more user profiles 110, and generate new messages and prompts for additional information according to the context of previously provided user responses. The one or more LLMs and/or other generative artificial intelligence processes implemented by the wellness system 102 are, in some examples, dynamically trained using a dataset comprising a large corpus of sample communications/messages (e.g., historical communications/messages, hypothetical communications/messages, combinations of historical and hypothetical communications/messages, etc.), sample embeddings corresponding to the sample communications/messages, sample key-value pairs corresponding to inferred attributes and preferences included in the sample communications/messages and corresponding to the sample embeddings, and sample responses to the communications/messages. The one or more LLMs and/or other generative artificial intelligence processes may be initialized with a first set of values corresponding to different hyperparameters or other coefficients that, in combination, are used to derive an output given a sample input (e.g., sample communications/messages). For instance, the wellness system 102 may initialize a set of coefficients or other hyperparameters randomly according to a Gaussian or non-Gaussian distribution. Using this initial iteration of the one or more LLMs or other generative artificial intelligence processes, the wellness system 102 may process the dataset of sample communications/messages to generate an output. This output may specify, for each sample communication or message, one or more key-value pairs corresponding to inferred attributes and preferences and a response to the communication or message (e.g., an extracted attribute or preference, a message to be communicated, etc.). The one or more LLMs or other generative artificial intelligence processes may compare the output (e.g., predicted attribute or preference, response message to be communicated, etc.) to the expected responses included in the dataset. Based on this comparison, the one or more LLMs or other generative artificial intelligence processes may dynamically update the values corresponding to the different hyperparameters or other coefficients and again process the dataset to generate new outputs. This process may be repeated numerous times until an iteration of the one or more LLMs or other generative artificial intelligence processes is obtained that satisfies one or more accuracy or predictability thresholds.

In some examples, the one or more LLMs or other generative artificial intelligence processes are further trained to improve the predictability of the one or more LLMs or other generative artificial intelligence processes in accurately identifying and generating user attributes from received communications or messages. For instance, in addition to evaluating the one or more LLMs or other generative artificial intelligence processes according to linguistic metrics (e.g., Bilingual Evaluation Understudy (BLEU) scores, language fluency metrics, semantic consistency metrics, etc.), the wellness system 102 may determine whether the one or more LLMs or other generative artificial intelligence processes are accurately leveraging available user profiles 110 and corresponding knowledge graphs to identify user attributes from the key-value pairs corresponding to the attributes that may be associated with a user profile. For instance, the wellness system 102 may evaluate the output generated by the one or more LLMs or other generative artificial intelligence processes to determine whether the one or more LLMs or other generative artificial intelligence processes are correctly converting the sample communications/messages into a set of embeddings and identifying appropriate key-value pairs of attributes that may be associated with a user profile according to this set of embeddings (e.g., correctly matching the set of embeddings to known attribute embeddings, etc.). Based on this evaluation, the wellness system 102 may dynamically update the one or more LLMs or other generative artificial intelligence processes as described above to improve the identification of user attributes by these one or more LLMs or other generative artificial intelligence processes. In some examples, the wellness system 102 may determine that the one or more LLMs or other generative artificial intelligence processes are not correctly converting a predetermined threshold number or percentage of the sample communications/messages into the set of embeddings. In some examples, meeting the threshold number/percentage may trigger an alert to an operator and/or user. In some examples, meeting the threshold number/percentage may trigger pausing of additional training until an operator intervenes (e.g., restarts the one or more LLM or other generative processes). In some examples, the one or more LLM or other generative processes may revert to a previous LLM or generative processes or to previous LLMs or other generative processes until an operator intervenes.

In response to a communication from the user to an AI agent 104, the wellness system 102, through the one or more LLMs or other generative artificial intelligence processes, may dynamically extract one or more key-value pairs corresponding to attributes from the communication and determine whether these one or more attributes correspond to one or more profile attributes that may be added to a user profile associated with the user and/or other related users associated with the family profile 106. As an illustrative example, if the AI agent 104, through the communications session, prompts the user to indicate who are the other users associated with the family profile 106, the wellness system 102 may evaluate any responses associated with this prompt to determine (through the one or more LLMs or other generative artificial intelligence processes) whether these responses include information that may indicate the other users associated with the family profile 106. For instance, if a response provided by the user includes one or more proper names (e.g., first names, etc.), the wellness system 102, through the one or more LLMs or other generative artificial intelligence processes, may extract these one or more proper names and calculate an inference confidence score for each of the one or more proper names to determine whether these one or more proper names correspond to other users associated with the family profile 106. As an illustrative example, if the user provides the response “We've got Miya and Maxine,” the wellness system 102 may extract the terms “Miya” and “Maxine” from the response and evaluate these terms against a knowledge graph of known proper names to calculate an inference confidence score for these terms.

The inference confidence score may denote a likelihood or confidence that the extracted term (or inferred attribute) corresponds to an attribute that may be associated with a user profile 110. In some cases, the wellness system 102 may establish a confidence threshold that may be used to determine whether an inferred attribute extracted from a user response can be considered a profile attribute that may be added to a user profile. For instance, if an inferred attribute extracted from a response is assigned an inference confidence score that is below the confidence threshold, the wellness system 102 may determine that the inferred attribute has a low likelihood of being a profile attribute that may be incorporated into a user profile. Alternatively, if an inferred attribute extracted from a response is assigned an inference confidence score that is equal to or greater than the confidence threshold, the wellness system 102 may determine that the inferred attribute corresponds to a profile attribute that should be added to a user profile. As described in greater detail herein, as user profiles are updated and as more inferred preferences or attributes are extracted from obtained communications, the wellness system 102 may further incorporate existing user attributes and prior user attribute confirmations and/or denials to calculate inference confidence scores for newly obtained inferred preferences or attributes.

The wellness system 102 may receive communications from external sources via APIs 116. APIs 116 include interfaces (e.g., network, software, and/or hardware interfaces) that enable communications with disparate devices. For example, the wellness system 102 may receive natural language communications from client devices via APIs 116, data from one or more external sources (e.g., information from sensors, IoT devices, surveillance devices such as cameras and/or microphones, databases, cloud networks, websites, servers, terminal devices, etc.), etc. APIs 116 may include interfaces to translate information into a format that that can be processed by the wellness system 102. In some examples, APIs 116 may translate particular data types into common data types. For instance, image data may be translated into an image data type, audio segments may be translated into an audio data type, video data may be translated into a video data type, etc. APIs 116 may pass communications and data to the wellness system 102 for further processing.

FIG. 2 is a block diagram of a system 200 for conversion of data streams to family goals, in accordance with various embodiments. In some examples, user device 130a produces data streams 210, which can be one or more real-time data streams associated with a user profile 110 and/or family profile 106. Data streams 210 include conversations 212, communications with IoT/Wearables devices 214, interactions 216 with the application 140a, events or calendar information 218, and communications with partners 220. For example, conversations 212 may include ongoing communications between one or more user devices and an AI agent 104. The data streams 210 can be converted into user attributes 112 and stored in a user profile 110. The user attributes 112 can be merged with attributes from other users into family attributes 108 included in family profiles 106. The family attributes 108 can be used by the wellness system 102 to determine family goals 230. Calendar information 218 may include local calendars stored on the user device, partner calendars from third party providers, such as schools, organizations, service providers, etc., other user's calendars, and/or family calendars. Communications with partners may include, as non-limiting examples, third party websites, account information (e.g., bank accounts, utility websites, credit card websites, fitness tracker accounts, health accounts, etc.), mobile applications, communications with service providers, schools, organizations (e.g., schools, churches, sports leagues, etc.), or the like.

The wellness system 102 may merge the user attributes 112 from different users and identify family goals 230 based on the family attributes 108. Once one or more family goals are identified, the family goals 230 may be broken down into activities 232, tasks 234, interactions 236, and/or events 238, as non-limiting examples. In some example, once the family goals 230 are identified, the family goals 230 may be provided to the set of users for approval via one or more user interfaces at each of the user devices 130a, 130b, etc. Additionally or alternatively, the family goals 230 may be provided to a user of the set of users that is the head of the family or admin for the group. Once the sets of users approve the family goals 230, the activities 232, tasks 234, interactions 236, and/or events 238 may be performed by the users to achieve the goals 230 identified using the family attributes 108.

In some examples, when a user associated with a family profile 106 accesses the wellness system 102 for the first time, the wellness system 102 may automatically assign an AI agent 104 to the user and initiate a new communications session between the user device 130a and the AI agent 104. The AI agent 104, in some instances, is dynamically trained to automatically identify and address user intents. Further, the AI agent 104 may be dynamically trained to prompt for and obtain different user attributes associated with different users (e.g., the user devices 130a, 130b, . . . 130n) based on the data streams 210 to convert the data streams 210 into user attributes 112 which may be provided to the family profile 106 and merged as family attributes 108. As described in greater detail herein, the merged attributes may be used to dynamically generate goals 230 and tasks that may be performed to achieve indicated family goals. The wellness system 102 may further generate customized responses to these user intents according to any applicable constraints. These customized responses may be generated according to known responses maintained by the wellness system 102 and/or to different data sources from which the wellness system 102 may derive these customized responses according to the corresponding intents.

In some examples, the wellness system 102 automatically processes data streams, such as conversations (e.g., communications shared through an ongoing communications session between a user and an AI agent 104, among multiple users and an AI agent, etc.) to identify different user attributes 112 for each of the related users and update corresponding user profiles 110 to incorporate these attributes 112. The wellness system 102 may comprise one or more computer systems of the wellness system 102 or may be implemented as an application or process executing on one or more computer systems associated with the wellness system 102.

In some examples, the wellness system 102, through the one or more LLMs or other generative artificial intelligence processes, evaluates the user profiles 110 corresponding to the family profile 106 and the previous communications exchanged during the ongoing communications session between the user and an AI agent 104 to generate new communications that may be exchanged with the user to obtain additional user attributes 112 for the user profiles 110. For instance, based on these previous communications, the wellness system 102 (through the one or more LLMs or other generative artificial intelligence processes) may dynamically determine the context of the ongoing communications session and provide to the AI agent 104 a response that is relevant to the ongoing communications session and is responsive to the user's communications. As an illustrative example, if a user provides the names of the other related users associated with the family profile 106, the wellness system 102 (through the one or more LLMs or other generative artificial intelligence processes) may determine that the AI agent 104 should prompt the user to the other user's relationship to the user. The AI agent 104 may subsequently present this response to the user through the ongoing communications session.

As the related users associated with the family profile 106 communicate with automated AI agents 104 implemented by the wellness system 102, the wellness system 102 may dynamically process any exchanged communications in real-time to extract any inferred attributes. Further, the wellness system 102, through the one or more LLMs or other generative artificial intelligence processes, may evaluate these inferred attributes according to any available user profile data corresponding to these related users to identify any user attributes that may be added to the user profiles corresponding to these related users.

In some examples, the wellness system 102 further processes conversation data corresponding to communications among the different related users to obtain additional attributes that may be evaluated to identify new attributes that may be assigned to these related users. For instance, the wellness system 102 may facilitate communications sessions among related users and that may include one or more automated AI agents 104 that may assist these related users with different tasks and goals. Through these communications sessions, related users may communicate with one another without automated agent intervention. As an illustrative example, through an ongoing communications session, a user may ask a related user whether they have completed a particular chore within the family home (e.g., taking out the garbage, doing the dishes, cleaning the bathroom, etc.). The wellness system 102, through the one or more LLMs or other generative artificial intelligence processes, may additionally process these communications among different related users to extract any additional attributes and, based on evaluation of these additional attributes and existing user profiles for the related users, identify and/or update any profile attributes for these existing user profiles.

In addition to processing conversation data from ongoing communications sessions, the wellness system 102, In some examples, further processes user interactions with one or more partner data sources 516 to obtain additional information that may be used to define user attributes for corresponding user profiles. For instance, when the related users access the wellness system 102 for the first time, the wellness system 102 may prompt these related users to authorize the wellness system 102 to access these partner data sources 516 to obtain additional data that may be used to enhance these users'user profiles. Partner (e.g., third-party) data sources 516 may include, but are not limited to, social media platforms, electronic mail services, calendaring services, personal fitness devices (e.g., fitness trackers, exercise equipment having communication capabilities, etc.), and the like. The data from these partner data sources 516 may further indicate different interactions among the related users and other information that may be used to further determine the family dynamics and identify additional user attributes that may be incorporated into the user profiles associated with these related users.

It should be noted that the wellness system 102 continuously, and in real-time, processes conversation data from different ongoing communications sessions (including ongoing communications sessions between related users and one or more automated AI agents 104 and ongoing communications sessions among these related users) and from the partner data sources 516 to continuously update and refine the user profiles associated with the related users. This may ensure that the user profiles accurately convey the unique attributes of each user associated with the family profile 106. Further, this may ensure that the relationships between these related users as defined through the user profiles closely mirror the unique dynamics of the family profile 106. This may allow the wellness system 102, through the automated AI agents 104, to better communicate with the different related users according to their unique attributes and according to the identified dynamics of the family profile 106.

The wellness system 102, through the continuous processing of this conversation data from different ongoing communications sessions and from the partner data sources 516, further improves the functionality of the various systems and processes of the wellness system 102. For example, by dynamically updating and refining the user profiles associated with the related users as these related users engage in different ongoing communications sessions and with partner data sources 516, the number of prompts provided by automated AI agents 104 to these related users may be reduced, as these automated AI agents 104 may no longer be required to directly prompt these related users for information corresponding to the unique dynamics of the family and to the unique attributes of each of the related users. By reducing the number of prompts required to obtain this data, the processing requirements of the wellness system 102 are reduced, thereby improving the efficiency of the various systems and processes of the wellness system 102.

In some examples, the wellness system 102 dynamically generates and provides recommendations for different tasks and projects that the family profile 106 may engage in according to indicated goals. In some examples, the wellness system 102 is configured to dynamically process conversation data corresponding to real-time communications exchanged between different related users and one or more automated AI agents 104 through ongoing communications sessions to dynamically identify one or more goals that the family profile 106 would like to achieve. For instance, the wellness system 102, using NLP or other language processing algorithm in conjunction with one or more LLMs or other generative artificial intelligence processes, may dynamically evaluate conversation data corresponding to ongoing communications sessions between different related users of a family profile 106 and one or more automated AI agents 104 to identify a goal that the family profile 106 wishes to achieve and for which the wellness system 102 may be used to identify possible tasks that may be performed to achieve the goal.

In some examples, the wellness system 102 implements and dynamically trains a machine learning algorithm or artificial intelligence to automatically generate a set of tasks that can be performed by the related users of the family profile 106 to achieve the identified goal. The machine learning algorithm or artificial intelligence utilized by the wellness system 102 to automatically, and dynamically, generate a set of tasks for accomplishing an identified goal may be trained using supervised training techniques. For instance, the machine learning algorithm or artificial intelligence may be trained using a dataset of sample goals, sample user profiles corresponding to different family profiles, and expected tasks performable to achieve the sample goals. The machine learning algorithm or artificial intelligence can be evaluated to determine, based on the sample inputs supplied to the machine learning algorithm or artificial intelligence from the dataset, whether the machine learning algorithm or artificial intelligence is producing a set of tasks that is conducive to achieving a corresponding sample goal. Based on this evaluation, the machine learning algorithm or artificial intelligence may be modified to increase the likelihood of the machine learning algorithm or artificial intelligence generating the desired results. The machine learning algorithm or artificial intelligence may further be dynamically trained by soliciting feedback from related users with regard to the tasks provided by the machine learning algorithm or artificial intelligence for given goals. For instance, the wellness system 102 may obtain new feedback from the related users after performance of a set of tasks generated by the wellness system 102 corresponding to a particular goal. The machine learning algorithm or artificial intelligence may use this feedback to determine whether the set of tasks were conducive to the related users achieving their goal. This determination may be used to further train the machine learning algorithm or artificial intelligence to provide better tasks that may be performed to achieve similar goals.

Through the machine learning algorithm or artificial intelligence, the wellness system 102 dynamically process the conversation data corresponding to the one or more ongoing communications sessions and the user profiles corresponding to the related users to identify a goal that the family would like to achieve and one or more tasks that may be performed by the related users to achieve the goal. The one or more tasks may be assigned to different related users according to the user attributes associated with each of the different related users. For example, if the family has expressed a goal to spend at least one-hundred and fifty minutes of active time together per week, the wellness system 102 may evaluate the user profiles corresponding to the related users to identify any current tasks associated with these related users that may impede the family profile's ability to achieve this goal. Additionally, the wellness system 102 may evaluate these user profiles to identify each user's role associated with the family profile 106, which may inform what tasks may be assigned to each user to achieve the goal. In some instances, the wellness system 102 further identify, based on the user profiles, different user characteristics that may inform the wellness system 102 as to how to encourage the different related users to perform the assigned tasks and achieve the goal. For example, if a particular user is motivated by competition with other users, the wellness system 102 may determine that this particular user should be provided with routine updates with regard to the performance of tasks assigned to the other related users. As another illustrative example, if a particular user is known to procrastinate when it comes to completing tasks, the wellness system 102 may determine that this particular user should be provided with routine reminders (e.g., notifications, alarms, motivating messages, etc.) to complete their assigned tasks.

In some examples, the wellness system 102 can provide the goal and the assigned tasks to the one or more automated AI agents 104 engaged in one or more ongoing communications sessions with the related users to communicate the goal and the assigned tasks to the related users. These one or more automated AI agents 104, through the one or more ongoing communications sessions, may present the goal and the tasks assigned to each user. Further, the automated AI agents 104 may provide tailored communications and interfaces through which a user may be presented with individualized motivators (e.g., graphics, messages, statistics, reminders, etc.) that may be implemented to encourage the user to achieve their assigned tasks.

Thus, the wellness system 102 further provides additional benefits that may improve the functionality of the automated AI agents 104. For instance, because the wellness system 102, through the continuous processing of this conversation data from different ongoing communications sessions and from the partner data sources 516, dynamically updates and refines the user profiles associated with the related users as these related users engage in different ongoing communications sessions and with partner data sources 516, the wellness system 102 may be more likely to identify family-based goals and corresponding tasks that comport with each user's characteristics. Furthermore, because the wellness system 102 leverages the family and user profiles dynamically updated and refined by the wellness system 102 in real-time, the need to prompt one or more related users for additional data usable for defining these tasks may be drastically reduced. This may result in additional reduction in the resources required by the wellness system 102 (e.g., memory, processing, network bandwidth, etc.) to identify family-based goals and to define corresponding tasks for achieving these goals.

In some examples, the wellness system 102 dynamically monitors performance of the related users for completion of their assigned tasks and to track the family profile 106 progression towards the specified goal. In some instances, a particular task that is to be performed by one or more related users of the family profile 106 may be subject to a deadline or other temporal limit. For example, if a particular goal is to be accomplished within a pre-defined timeframe, each task assigned to the one or more related users of the family profile 106 may need to be performed according to their respective deadlines or other temporal limits in order to ensure that the requisite progress is being made towards achieving the stated goal. Accordingly, wellness system 102 may, in real-time, process any messages as they are exchanged between the different related users and the one or more automated AI agents 104 through the ongoing communications sessions (e.g., communications sessions specific to the assigned tasks, communications sessions associated with the goal, etc.) to determine whether the assigned tasks associated with the goal have been performed or are in the process of being performed.

If a task associated with the stated goal has been completed, the wellness system 102 may indicate, via interfaces provided to the related users (e.g., graphical user interfaces provided through applications installed on family profile computing devices, interfaces provided through a web service, etc.), that the task has been completed. Further, the wellness system 102 may update these interfaces to provide an indication of how the family profile 106 is progressing towards achieving the stated goal. In some instances, the wellness system 102 may update these interfaces to provide a graphical indication that the task has been completed. For example, the wellness system 102 may move the completed task to a section of the interfaces corresponding to completed tasks (e.g., a “Completed To-Dos” section of the interfaces, etc.). This process may continue until the tasks associated with the stated goal are completed and the stated goal is presumed achieved.

In some examples, the wellness system 102 can detect when one or more tasks assigned to the related users have not been completed within their respective deadlines or other temporal limits and accordingly perform one or more actions to motive the related users to complete these one or more tasks. As noted above, the wellness system 102 may monitor the performance of tasks associated with a stated goal in real-time. This may include processing messages between each user and automated AI agents 104 as these messages are exchanged over the communications sessions associated with each of these tasks. The wellness system 102 may utilize a machine learning algorithm or artificial intelligence (e.g., NLP) to process these messages in real-time and determine the status of each task assigned to the related users. For example, if a user indicates, in a message to an AI agent 104 through a communications session corresponding to a task assigned to the user, that they are unable to perform the assigned task within the time allotted for the task, the wellness system 102 may determine that the assigned task will not be completed within the time allotted for the task. As another example, the wellness system 102 may determine that no action or information corresponding to performance of the task has been received at the end of the time allotted for the task. This may cause the wellness system 102 to prompt the AI agent 104 to communicate with the user to determine whether the task has been completed. If the user indicates that the task has not been completed, the wellness system 102 record the task as not having been completed within the allotted time for the task.

In some instances, if the wellness system 102 detects that a task assigned to a particular user of the family profile 106 has not been completed within the allotted time frame, the wellness system 102 may automatically process the user profile 110 to identify one or more actions that may be performed to motivate the user to complete the assigned task. As noted above, the wellness system 102 may identify, based on the user profiles, different user characteristics that may inform the wellness system 102 as to how to encourage the different related users to perform the assigned tasks and achieve the goal. Based on this evaluation of the user's profile and the other user profiles associated with the other users of the family profile 106, the wellness system 102 may dynamically identify an action that may be performed by the wellness system 102 and/or an AI agent 104 to motivate the user to complete the task. As an illustrative example, if the user is motivated by routine notifications or alarms that may serve to remind the user of tasks that need to be completed, the wellness system 102 may update the interface provided by the wellness system 102 to this user to provide a notification or alert that the task has not been completed. As another illustrative example, if the user is motivated by competition with other users of the family profile, the wellness system 102 may update the interface to indicate how other users are completing their assigned tasks. Further, the wellness system 102, through one or more automated AI agents 104, may transmit a notification to these other users to indicate that the user has not completed their assigned task.

In some examples, the wellness system 102 can collect data from personal fitness devices and other sources to determine whether an assigned task has been completed. A user associated with an assigned task may provide the wellness system 102 with access to these one or more member resources, whereby the wellness system 102 may periodically or at particular times access these member resources to obtain task-related data that may be used to determine whether tasks assigned to the user are being completed according to the allotted times for completion of these tasks. As an illustrative example, if a particular task involves having the user perform interval training followed by a one-mile run by a given time, the wellness system 102 can obtain data from one or more fitness devices associated with the user's user profile. The data may include Global Positioning System (GPS) data, steps data, heart rate readings, blood pressure readings, PaO2 readings, and the like. Using this data, the wellness system 102 may automatically determine if the user has completed the particular task. The wellness system 102, in some instances, may also prompt the AI agent 104 associated with the assigned task to communicate with the user regarding these readings to determine whether the assigned task has been completed. For example, if the GPS data for the user indicates that the user may have run a mile during the allotted time for the assigned task, the AI agent 104 may transmit a message to user over the communications session corresponding to the particular task to prompt the user to indicate whether the particular task has been completed.

The wellness system 102 may continue to monitor performance of the tasks associated with the stated goal to determine whether the stated goal has been achieved. For instance, as the related users complete their assigned tasks associated with the stated goal, the wellness system 102 may automatically, and in real-time, record the progress towards achieving the stated goal. Additionally, the wellness system 102 may monitor and process messages among the related users and the automated AI agents 104 (e.g., communications sessions associated with assigned tasks, communications sessions through which related users communicate with one another, etc.) in real-time and as these messages are exchanged to determine the progress towards achieving the stated goal. These messages may serve as feedback regarding each performed task and to the overall structure of the set of tasks for achieving the stated goal. Further, once the set of tasks corresponding to the stated goal have been completed, the wellness system 102 may prompt the related users for feedback regarding the set of tasks and as to whether the stated goal was achieved as a result of performance of the set of tasks. If the related users indicate that the set of tasks helped the family profile 106 achieve the stated goal, the wellness system 102 may assign a positive polarity to the set of tasks and the timeframe utilized for achieving the stated goal. Alternatively, if the related users indicate that the set of tasks were unfavorable and/or that performance of the set of tasks did not result in the family profile 106 achieving the stated goal, the wellness system 102 may assign a negative polarity to the set of tasks and timeframe utilized for achieving the stated goal. The obtained feedback can be used to update or retrain the machine learning algorithm or artificial intelligence utilized by the wellness system 102 to generate different tasks that may be performed to achieve similar goals for similarly situated family profiles.

In some instances, the wellness system 102 may dynamically update the goal and/or any tasks assigned to the different related users in real-time as the user profiles associated with the related users are dynamically updated through real-time and continuous processing of conversation data from different ongoing communications sessions and from the partner data sources 516. For example, as the wellness system 102 updates the user profiles through the continuous process of conversation data, the wellness system 102 may dynamically process the previously identified goal and corresponding tasks through the aforementioned machine learning algorithm or artificial intelligence to determine whether any changes to the goal and/or any of the corresponding tasks should be implemented to improve the likelihood of the goal being achieved. If the wellness system 102 identifies one or more changes to the goal and/or the corresponding tasks that should be implemented for the family profile 106, the wellness system 102 may communicate these changes to the different related users through the aforementioned automated AI agents 104. Additionally, based on these updated profiles, the changes may be communicated according to each user's characteristics.

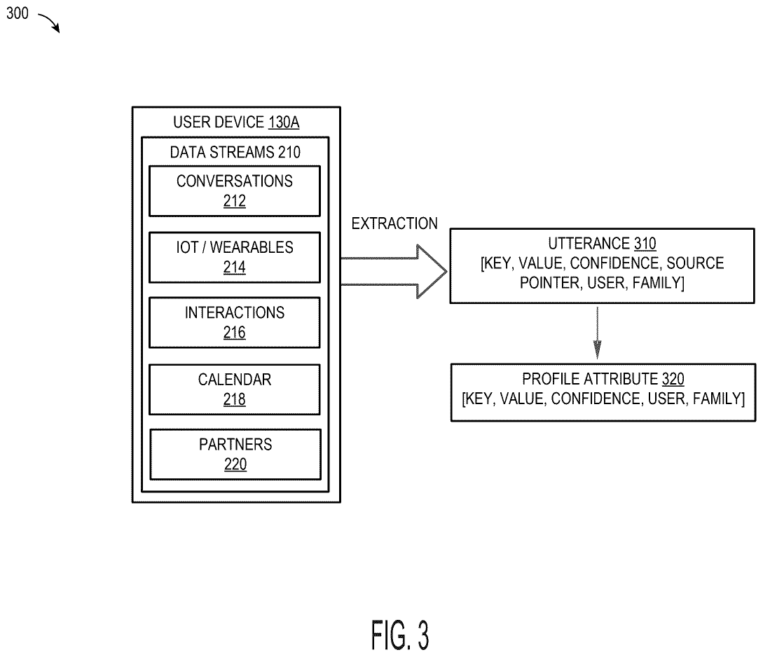

FIG. 3 is a block diagram 300 of an example of a system for extraction of attributes based on data streams related to a user by the wellness system 102. In some examples, the data streams 210 include conversations 212, communications with IoT/Wearables devices 214, interactions 216 with the application 140a, event or calendar information 218, and communications with partners 220. as described above with regards to FIG. 2. In some examples, the wellness system 102 may extract information from one or more data streams 210 (e.g., utterances 310) prior to converting the one or more data streams to attributes. The utterances 310 may include but are not limited to, a key, a value, a confidence score, a source pointer, user information, and/or family information using one or more LLMs as described above. In some examples, the keys may include attribute types while values may include corresponding values for the attributes. For example, keys may include attribute types such as diet, relationship, allergies, hobby, favorite flower, etc., while values may be specific information related to the keys (e.g., vegan, wife, nuts, cycling, and sunflowers). Profiles for users and/or families may be constructed using key-value pairs. A confidence score may be assigned by the wellness system 102 while extracting information from the data streams 210. The confidence score may be a probability related to accuracy of the attributes extracted from the one or more data streams 210. A source pointer may be included, which is a specific data field or pointer linking a stored/inferred attribute back to a location in the data stream where the attributes were extracted. In some examples, user information may be included in the extracted data, such as a user identifier, a name, a nickname, or other reference to a user that may be used by the wellness system 102 to link the information extracted to a user profile and/or a family profile. In some examples, a user device identifier may be included in the attributes and/or extracted data (e.g., MAC address, serial number, phone number, etc., or combinations thereof). In some examples, the utterances 310 may be stored in the user profile and/or the family profile. In some other examples, the utterances 310 may be converted to attributes by removing or adding fields of data and then stored in the user profile(s) and/or or family profile. In some examples, the utterances may include multiple user identifiers and/or multiple user device identifiers. For example, an utterance may originate from a user device 130a but may include information regarding a user associated with another user device (e.g., 130b), in which case, the utterances may include multiple user identifiers and/or multiple user device identifiers. The family profile 106 may include any or all of the information included in each user profile and/or may include a reference number for the user profile in order to link user profiles back to the family profile 106. In some examples, user profiles may be linked to more than one family profile 106, if for example, a user is participating in a group that includes extended family, a group that includes immediate family, a group that includes friends, etc.

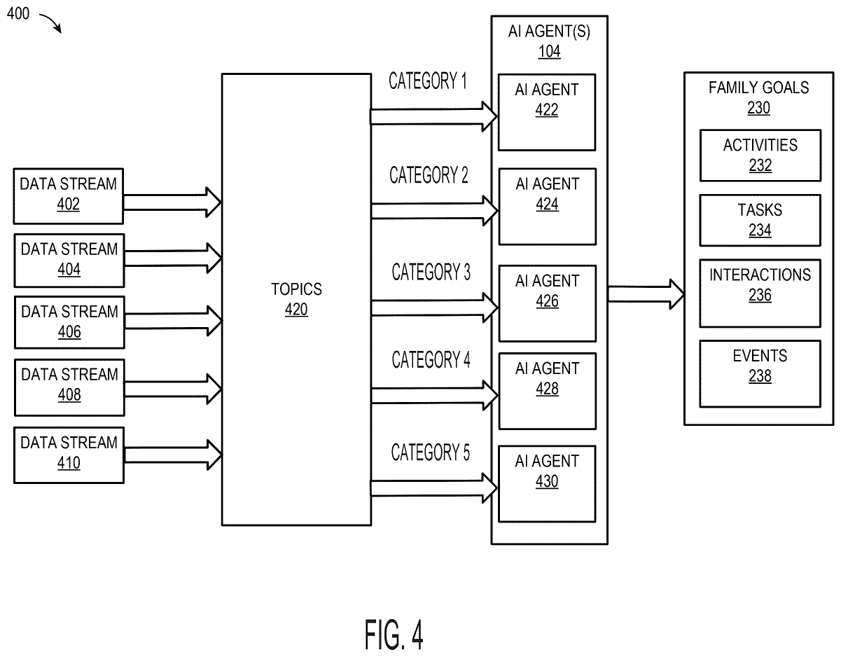

FIG. 4 is a diagram of a system 400 for raw data extraction for creation of a family profile, in accordance with various embodiments. System 400 illustrates processing of multiple data streams 402, 404, . . . 410 by the exemplary wellness system 102. The data streams 402, 404, . . . 410 may be produced by one or more user devices. After processing the data streams 402, 404, . . . 410 for utterances/attributes as described above, topics 420 may be determined. The wellness system 102 may generate one or more categories using topics 420. In some examples, each of the categories may be assigned to an AI agent 422, 424, . . . 430. The AI agents 104 may work in parallel to handle multiple requests simultaneously, to develop family goals 230 including activities 232, tasks 234, interactions 236, and/or events 238. For example, one or more users may input problems or difficulties with which they would like the wellness system 102 to develop a plan. The wellness system 102 may determine various topics 420 based on the input from the user and use the AI agents 104 to develop a step-by-step plan to be implemented by the user, related users, and/or one of the AI agents 104.

As a non-limiting example, based on a conversation in a chat interface among users and an agent AI 104, the wellness system 102 may determine that based on the current family goals, the family would benefit from a health wellness plan, one of the users would benefit from a home assistance plan, and another user would benefit from a to-do plan. AI agent 422 may be tasked with generating the to-do plan, and may chat in the existing chat interface including the family members or may generate a new chat interface specifically for the to-do plan. The AI agent 422 may interact with the set of users by asking questions to gather additional details regarding the goals for the health wellness plan. The AI agent 422 may gather information in the form of a dialogue with the set of users until the AI agent 422 is able to generate a step-by-step plan including, for example, providing timelines, recipes, grocery lists, workout schedules, etc. The AI agent 422 may populate a family calendar and/or each user's calendar using the step-by-step plan.

For example, the AI agent 422 may take into account the family attributes and user attributes from the family profile and the user profiles to suggest tasks and/or activities. For example, ages of the different family members, varying physical abilities of the family members, budget constraints for individuals and/or the family, weather, available time, distance from the family home (or family homes if users are not living in the same home), etc. may be taken into account. For example, if the family includes an elderly person, a child, or someone who has an injury, the AI agent 422 may suggest and/or populate the family calendar with a weekly walk in the park. The AI agent 104 may additionally suggest aerobics and strength training classes for another family member who is more active, and present another user with options for nearby soccer leagues that can accommodate the user's current schedule based on their availability, fitness level, and/or interests. In some examples, the AI agent 422 may suggest the weekly walk in the park to the family members and allow the family members to offer suggestions or alternatives to the weekly walk in the park (e.g., a walk near the river, walking at a nearby mall, etc.), in order to foster engagement and collaboration from the family members.

Simultaneously, AI agent 424 may be tasked with providing the home assistance plan to one of the users. The AI agent 424 may gather additional details from the user vi a chat interface, a voice call, etc. The AI agent 424 may break the home assistance plan down into actionable steps (e.g., providing a daily and/or weekly breakdown of home tasks, providing a schedule of garbage pickup days and corresponding times to clean the refrigerator and/or take out the trash, etc.). AI agent 426 may be tasked with providing a to-do list to another user of the set of users. The AI agent 426 may take into account the user's schedule, interests, etc. based on the user's profile and determine the user's priorities based on the user's profile and/or based on communications with the user. After taking into account, for example, the user's work schedule, an upcoming triathlon, and the user's chores, the AI agent 426 may provide a suggested prioritized to-do list that includes a schedule of all the user's commitments and current calendar (e.g., work and/or family calendars). The prioritized to-do list may list items that should be completed and due dates for user to review. The user may accept or provide changes to the AI agent 426 before the AI agent 426 updates the user and/or family calendars with appropriate information. In some examples, the AI agent 426 may show times as blocked off for the user to other family members depending on user's desired privacy settings.

In some examples, the AI agent 104 may manage one or more calendars for the users and/or the family. For example, the AI agent 104 may include a calendar sweep feature which checks calendars for conflicts based on information extracted from the one or more data streams. The AI agent 104 may check work calendars for each of the users, personal calendars, family calendars, etc. In some examples, if a conflict is found, the AI agent may alert the user with the calendar conflict and/or the family. Conflicts may occur, for example, at a family level, at a user level, or between related users. In some examples, a conflict may be identified while in a conversation. For example, a user may suggest the family have a move night every other Friday at 7 pm in a chat among the user, related users, and the AI agent. The AI agent may inform the users in the chat interface that one of the users has a conflict for one or more of the suggested times. The users may offer alternatives which may be checked for conflicts by the AI agent, or the AI agent may offer times that do not contain conflicts for any of the users. In some examples, the AI agent may check partners or third parties for conflicts. For example, the AI agent may check certain movie theater companies for showtimes and suggest more specific times and/or movies for the movie night or other alternatives, such as a movie that will begin streaming on a certain date based on user attributes 112 in the user profiles and/or family attributes 108 in the family profile 106.

In some examples, the AI agent 104 may help a set of users plan an event, such as a birthday party, anniversary, graduation party, holiday dinner, etc. For example, the AI agent 104 may check dates to see when users are available. In some examples, the AI agent 104 may help users with tasks related to the event, such as making a list of things to do for the event, buying presents, making a guest list, creating an invitation, preparing mailing labels or a list of email addresses/phone numbers, etc. In some examples, different AI agents 104 may be assigned to each of the tasks related to the event, one AI agent may be assigned to the event and other sub-AI agents to tasks for the event, etc.

In some examples, the AI agent may check for conflicts related to an event. Continuing with the example of planning an event such as a birthday party, the AI agent may check for conflicts if a time and/or date is proposed. Conflicts may be checked in individual user's work calendars, personal calendars, and/or the family calendars. In some examples, external source may be checked, such as partner websites or partner calendars. For example, an AI agent 104 may determine that a scheduled day and time will not work due to a sporting event occurring at the same time, such as a soccer match, if soccer is an attribute for the family group and/or one or more users of the family that is found in user profile(s) and/or the family profile. Additionally or alternatively, the AI agent may check for task conflicts. For example, purchasing a birthday cake may be assigned to one of the users, but the AI agent 104 may infer from a conversation/chat that a different user is purchasing the cake. The AI agent 104 may notify one or more of the users that multiple people are tasked with purchasing the cake. In some examples, the AI agent 104 may customize the alerts so that all family members receive the alert except for one family member, if for example, the AI agent infers that the birthday party is a surprise party for one of the users in the family. In some examples, the AI agent may notify all of the family members except for one via a chat interface excluding the user (e.g. a chat with a dedicated AI agent 104 for the surprise birthday party, a newly created chat for the alert, etc.) or may send am email, text, call, etc. to the family members excluding the user.

In some examples, the AI agent may regularly check for conflicts associated with calendars, schedules, goals, tasks, recommendations, etc. and notify users and/or family members of conflicts or potential conflicts.

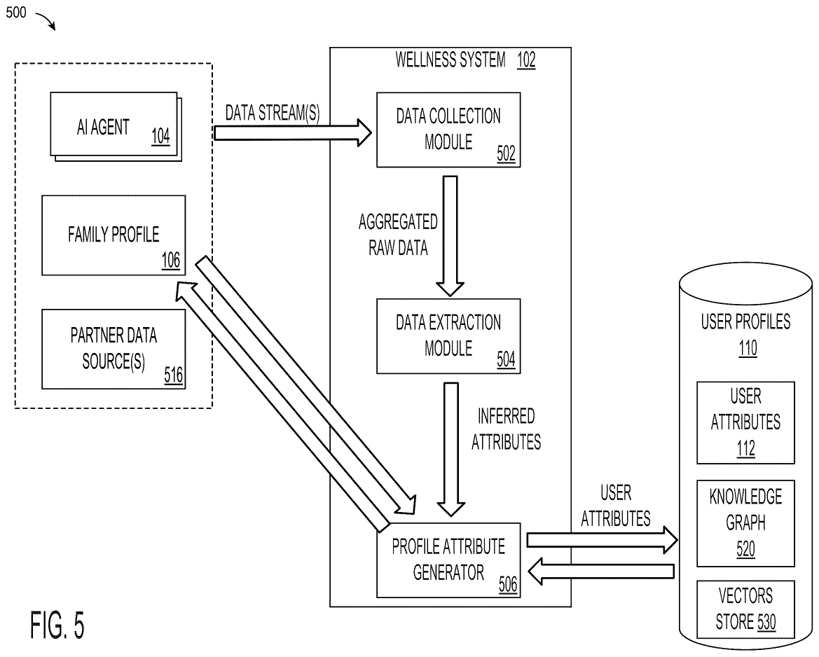

FIG. 5 is a diagram of a system 500 for a creation of a family profile, in accordance with various embodiments. System 500 includes a wellness system 102 configured to dynamically process data streams from different data sources to extract inferred user attributes for updating different user profiles and to further define relationships among the user profiles. In some examples, the wellness system 102 implements a data collection module 502 that is configured to obtain, real-time data streams from automated AI agents 104, a family profile 106, and partner data sources 516 associated with the family profile 106. The data collection module 502 may be implemented using a computer system or as an application or other executable code implemented on a computer system of the wellness system 102.

As noted above, when a user associated with a family profile 106 accesses the wellness system 102 for the first time, the wellness system 102 may automatically assign an AI agent 104 to the user and initiate a new communications session between the user and the AI agent 104. When a new communications session is established between a user and an AI agent 104, the AI agent 104 may automatically prompt the user to provide identifying information associated with the user and any other users corresponding to the family profile 106. For instance, when the user first engages the AI agent 104 through a new communications session, the AI agent 104 may determine whether there is an existing relationship between the user and other users of the wellness system 102. Returning to an earlier illustrative example, the AI agent 104 may prompt the user to provide detailed information with regard to the composition of the user's family profile 106 (e.g., number of inhabitants in the member's home, the number of children in the member's home, the number and types of pets in the member's home, etc.), the physical location of the member's home, any special needs or requirements of the user and of any other users associated with the family profile 106 (e.g., physical or emotional disabilities, etc.), and the like. In some instances, the user may be prompted to provide demographic information (e.g., age, ethnicity, race, languages written/spoken, etc.) associated with the user and any other users associated with the family profile 106. The user may also be prompted to indicate any personal goals that may be used to identify possible tasks that may be performed in order to achieve these goals.

In some examples, the wellness system 102 further implements different communications sessions between different automated AI agents 104 and different users of a family profile 106. This allows the wellness system 102, through the different communications sessions and different automated AI agents 104, to have tailored communications with different users of the family profile 106 according to the characteristics of each of these different users. For instance, when a first user associated with a family profile 106 accesses the wellness system 102 and initiates a communications session with an AI agent 104, the user may provide information corresponding to other users associated with the family profile 106. Using this information, the wellness system 102 may transmit a notification (such as through an electronic mail message, text message, etc.) to these other users to invite these users to access the wellness system 102. If another user accesses the wellness system 102 in response to this notification, the wellness system 102 may facilitate a new communications session between this other user and an AI agent 104 (e.g., the same automated agent as the one communicating with the first user, a different automated agent, etc.). Further, the wellness system 102 may allow this other user to communicate with the first user through an existing communications session and/or through a new communications session. In some examples, as users associated with the family profile 106 communicate with different automated AI agents 104 through different ongoing communications sessions, the data collection module 502 may obtain, in real-time, any communications exchanged between these users and the different automated AI agents 104. For instance, as users submit responses to prompts provided by automated AI agents 104 through these ongoing communications sessions, these responses are automatically transmitted to the data collection module 502.

The data collection module 502 may further obtain raw data from the users associated with the family profile 106 directly. As noted above, the wellness system 102 may facilitate communications sessions among the different users of a family profile 106 to allow these users to communicate amongst themselves without automated agent intervention. Returning to an earlier illustrative example, through an ongoing communications session, a user may ask a different user whether they have completed a particular chore within the family home (e.g., taking out the garbage, doing the dishes, cleaning the bathroom, etc.). The data collection module 502 may automatically monitor these communications sessions and obtain, in real-time, any communications exchanged among these users.

The data collection module 502 may further process user interactions with one or more partner data sources 516 to obtain additional information that may be used to define user attributes for corresponding user profiles. As noted above, when the users access the wellness system 102 for the first time, the wellness system 102 may prompt these users to authorize the wellness system 102 to access these partner data sources 516 to obtain additional data that may be used to enhance these users' user profiles. The data from these partner data sources 516 may further indicate different interactions among the users and other information that may be used to further determine the family dynamics and identify additional user attributes that may be incorporated into the user profiles associated with these users and the family profile 106.

In some examples, the data collection module 502 applies NLP or any other language parsing algorithm or executable code to automatically parse any communications exchanged amongst the users of the family profile 106 and any communications exchanged between users and automated AI agents 104. Through this parsing of obtained communications, the data collection module 502 may dynamically identify different terms and phrases expressed by different users that may be used to identify different attributes associated with these users and with the family profile 106 as a whole. The NLP may be dynamically trained using a dataset of sample communications/messages (e.g., historical communications/messages, hypothetical communications/messages, combinations of historical and hypothetical communications/messages, etc.) and sample embeddings corresponding to the sample communications/messages. To dynamically train the NLP, the wellness system 102 may generate an initial iteration of the NLP. For instance, the wellness system 102 may initialize a set of coefficients or hyperparameters randomly according to a Gaussian distribution with low variance centered around zero. Using this initial iteration of the NLP, the wellness system 102 may process the dataset of sample communications/messages and corresponding embeddings to generate an output. This output may specify, for each sample communication/message included in the dataset, a predicted set of embeddings. The wellness system 102 may compare the predicted set of embeddings generated using the initial iteration of the NLP to the sample embeddings defined in the dataset for each of the data points (e.g., sample communications/messages) to identify any inaccuracies or other errors.

If the output of the NLP does not satisfy one or more criteria, the wellness system 102 may iteratively update one or more coefficients of the set of coefficients to generate a new iteration of the NLP. This new iteration of the NLP may be used to process the aforementioned training dataset, as well as any additional data points or other datasets obtained by the wellness system 102 to generate a new output for each data point in the training dataset. In some instances, the wellness system 102 may use an optimization algorithm to iteratively update the one or more coefficients of the set of coefficients associated with the NLP. The wellness system 102 may use this new iteration of the NLP to process the available data points and generate a new output. The wellness system 102 may evaluate this new output to determine whether the output satisfies the one or more criteria. This process of updating the set of coefficients associated with the NLP according to the one or more criteria may be performed iteratively until an iteration of the NLP is produced that satisfies the one or more criteria. Thus, using NLP or other any other language parsing algorithm or executable code, the data collection module 502 may dynamically convert obtained communications into different embeddings that may correspond to different inferred attributes and preferences that may be associated with different users of the family profile 106.

In some examples, as the data collection module 502 collects raw data from the different data sources described above (i.e., automated AI agents 104, the family profile 106 itself, and the partner data sources 516), the data collection module may aggregate this raw data and provide the aggregated data to a data extraction module 504 of the wellness system 102 for further processing. The data extraction module 504 may be implemented using a computer system or as an application or other executable code implemented on a computer system of the wellness system 102. The data extraction module 504, In some examples, dynamically trains and implements one or more LLMs and/or other generative artificial intelligence processes to evaluate aggregated raw data from the data collection module 502 to identify one or more attributes that may be associated with the users of the family profile 106. These one or more LLMs and/or other generative artificial intelligence processes may be dynamically trained using a dataset comprising a large corpus of sample data (e.g., historical data and corresponding embeddings, hypothetical data and corresponding embeddings, combinations of historical data and corresponding embeddings, etc.) and sample key-value pairs corresponding to inferred attributes and preferences corresponding to the sample embeddings. The one or more LLMs and/or other generative artificial intelligence processes may be initialized with a first set of values corresponding to different hyperparameters or other coefficients that, in combination, are used to derive an output given a sample input (e.g., sample data). For instance, the wellness system 102 may initialize a set of coefficients or other hyperparameters randomly according to a Gaussian or non-Gaussian distribution. Using this initial iteration of the one or more LLMs or other generative artificial intelligence processes, the wellness system 102 may process the dataset of sample data to generate an output. This output may specify, for each sample data point (e.g., sample embeddings corresponding to one or more sample communications, etc.), one or more key-value pairs corresponding to inferred attributes and preferences. The one or more LLMs or other generative artificial intelligence processes may compare the output (e.g., predicted inferred attribute or preference, etc.) to the expected key-value pair included in the dataset. Based on this comparison, the one or more LLMs or other generative artificial intelligence processes may dynamically update the values corresponding to the different hyperparameters or other coefficients and again process the dataset to generate new outputs. This process may be repeated numerous times until an iteration of the one or more LLMs or other generative artificial intelligence processes is obtained that satisfies one or more accuracy or predictability thresholds.

In some examples, the one or more LLMs or other generative artificial intelligence processes implemented by the data extraction module 504 may further calculate an inference confidence score for each inferred preference and attribute generated based on the obtained data. As noted above, an inference confidence score may denote a likelihood or confidence that the extracted term (or inferred attribute) corresponds to an attribute that may be associated with a user profile. An inference confidence score may be calculated using named entity recognition (NER) tagging, joint entity recognition and disambiguation (JERL), or other NLP-based process. For example, the data extraction module 504 may process the obtained data using the one or more LLMs or other generative artificial intelligence processes and a selected NLP-based process (e.g., NER, JERL, etc.) to generate key-value pairs corresponding to different inferred attributes and preferences. Each of these key-value pairs may be designated as a tag. Further, for each of these tags, the one or more LLMs or other generative artificial intelligence processes may assign a confidence score, whereby a higher confidence score denotes a greater confidence in the accuracy of the tag identification performed using selected NLP-based process. The determination of confidence scores may be tuned over time, as additional data points (e.g., communications and key-value pairs/tags) are obtained and used to train the one or more LLMs or other generative artificial intelligence processes. For example, tags and corresponding confidence scores, as well as the original communications and other data obtained from the aforementioned data sources, may be evaluated to determine whether the one or more LLMs or other generative artificial intelligence processes are accurately assigning tags to the embeddings provided by the data collection module 502. For example, if the one or more LLMs or other generative artificial intelligence processes assigns a high confidence score to a key-value pair corresponding to a particular inferred attribute that has been assigned to one or more data points, and the key-value pair does not actually correspond to the one or more data points, the one or more LLMs or other generative artificial intelligence processes may be retrained to reduce the likelihood (e.g., confidence score) for similar classifications of data.

As the data extraction module 504, through the aforementioned LLMs or other generative artificial intelligence processes, generates new attributes from the obtained data, the data extraction module 504 may provide these new attributes, as well as corresponding inference confidence scores, to a profile attribute generator 506 of the wellness system 102 to identify any profile attributes associated with different users and/or the family profile 106 that may be incorporated into corresponding user profiles 110. The profile attribute generator 506 may be implemented using a computer system or as an application or other executable code implemented on a computer system of the wellness system 102.

In some examples, the profile attribute generator 506 implements and dynamically trains one or more LLMs or other generative artificial intelligence processes to evaluate inferred attributes and preferences generated by the data extraction module 504 against existing attributes indicated in existing user and family profile profiles to determine whether to merge these inferred attributed and preferences with these existing attributes. The profile attribute generator 506, as described in greater detail herein, may access a knowledge graph and vector store within the wellness system 102 or a database 118 including the user profiles 110 to perform a semantic similarity process through the one or more LLMs or other generative artificial intelligence processes and map the inferred attributes and preferences to known attributes that may be defined in user and family profile profiles. Accordingly, the one or more LLMs or other generative artificial intelligence processes may convert the attributes into proposed user attributes that may be incorporated into one or more user profiles.

In some instances, the profile attribute generator 506 may evaluate the inference confidence score associated with each received inferred preference and attribute to determine whether the inferred preference and attribute should be processed further. As noted above, the wellness system 102 may establish a confidence threshold that may be used to determine whether an inferred attribute extracted from a user response can be considered a profile attribute that may be added to a user profile. For instance, if an inferred attribute extracted from a response is assigned an inference confidence score that is below the confidence threshold, the profile attribute generator 506 may automatically determine that the inferred attribute has a low likelihood of being a profile attribute that may be incorporated into a user profile. Accordingly, the profile attribute generator 506 may discard the key-value pair corresponding to this inferred attribute. Alternatively, if an inferred attribute extracted from a response is assigned an inference confidence score that is equal to or greater than the confidence threshold, the profile attribute generator 506 may determine that the inferred attribute corresponds to a profile attribute that should be added to a user profile.

For any attributes that satisfy the inference score threshold, the profile attribute generator 506, through the one or more LLMs or other generative artificial intelligence processes may evaluate the user profiles corresponding to the family profile 106 according to the knowledge graph and vector store to determine whether to merge these attributes with existing attributes defined in the user profiles. For instance, a user profile may include data corresponding to different attributes that have been confirmed by the corresponding user (i.e., user) or rejected by the corresponding user. The profile attribute generator 506, through the one or more LLMs or other generative artificial intelligence processes and using the knowledge graph and vector store, may compare an obtained inferred attribute to the user attributes defined in the user profiles associated with the family profile 106 and the data corresponding to confirmed and rejected attributes to determine whether the inferred attribute may be merged with an existing user profile. If the profile attribute generator 506 determines that an inferred attribute is associated with a user attribute that was previously rejected by the corresponding user, the profile attribute generator 506 may discard the inferred attribute. Alternatively, if the inferred attribute is associated with a user attribute that has not been previously associated with the user or is associated with an existing user attribute within the user profile, the profile attribute generator 506 may merge this inferred attribute with the user profile to associate this inferred attribute with the user.

As noted above, the wellness system 102 continuously, and in real-time, processes conversation data from different ongoing communications sessions and from the partner data sources 516 to continuously update and refine the user profiles associated with the users associated with the family profile 106. This may ensure that the user profiles accurately convey the unique attributes of each user associated with the family profile 106. Further, this may ensure that the relationships between these users as defined through the user profiles closely mirror the unique dynamics of the family profile 106. This may allow the wellness system 102, through the automated AI agents 104, to better communicate with the different users according to their unique attributes and according to the identified dynamics of the family profile 106.

Further, as noted above, the wellness system 102, through the continuous processing of this conversation data from different ongoing communications sessions and from the partner data sources 516, improves the functionality of the various systems and processes of the wellness system 102. Returning to an earlier illustrative example, by dynamically updating and refining the user profiles associated with the users as these users engage in different ongoing communications sessions and with partner data sources 516, the number of prompts provided by automated AI agents 104 to these users may be reduced, as these automated AI agents 104 may no longer be required to directly prompt these users for information corresponding to the unique dynamics of the family and to the unique attributes of each of the users. By reducing the number of prompts required to obtain this data, the processing requirements of the wellness system 102 are reduced, thereby improving the efficiency of the various systems and processes of the wellness system 102.

In some examples, the profile attribute generator 506 evaluates proposed user attributes to determine whether to merge the proposed user attributes with known attributes within existing family-based user profiles in accordance with at least one embodiment. The profile attribute generator 506 may obtain, from the data extraction module 504, attributes corresponding to different users of a family profile in real-time as these attributes are generated. In some examples, the profile attribute generator 506 automatically monitors the data extraction module 504 to identify and automatically retrieve any newly generated attributes generated by the data extraction module 504.

The profile attribute generator 506 may evaluate each obtained inferred attribute according to an inference score threshold to determine whether the inferred attribute may be considered for inclusion as a user attribute within a user profile. Returning to an earlier illustrative example, if an inferred attribute extracted from a response is assigned an inference confidence score that is below the inference confidence threshold, the profile attribute generator 506 may automatically determine that the inferred attribute has a low likelihood of being a profile attribute that may be incorporated into a user profile. Accordingly, the profile attribute generator 506 may automatically discard the key-value pair corresponding to this inferred attribute. Alternatively, if an inferred attribute extracted from a response is assigned an inference confidence score that is equal to or greater than the confidence threshold, the profile attribute generator 506 may determine that the inferred attribute corresponds to a profile attribute that should be added to a user profile. The profile attribute generator 506 may automatically transmit any attributes having inference confidence scores greater than the inference score threshold to the family profile 106 for merging with the family profile data.

In some examples, if the profile attribute generator 506 determines that a proposed family attribute is not associated with any known user profiles 110, the profile attribute generator 506 can automatically generate a new user profile corresponding to this newly identified user and incorporate this proposed family attribute into the new user profile. Returning to an earlier example, where a user has provided a response to a prompt that names two other users within the set of users, the profile attribute generator 506 may dynamically generate two new user profiles for these two other users if there are no existing user profiles corresponding to these two other users. Further, the profile attribute generator 506 may annotate these two new user profiles to denote that the two other users are associated with the set of users.

In some instances, using the knowledge graph 520 and the vectors store 530, the profile attribute generator 506 may further merge the new family attributes with existing family attributes within different user profiles based on the relationship among the different users in the family profile. For example, if a proposed family attribute denotes that Miya is Joe's daughter, the profile attribute generator 506 may use the knowledge graph 520 and the vectors store 530 to determine that the proposed family attribute is to be incorporated into Miya's profile and into Joe's profile and denote the relationship between Miya and Joe. This may result in Miya's profile denoting that she is Joe's daughter. This may further result in Joe's profile denoting that he is Miya's father. As another illustrative example, if a proposed family attribute indicates that the family profile is vegan, the knowledge graph 320 may access the family profile to identify the different users associated with the family profile. Further, based on this identification of the different users that are part of the family profile, the profile attribute generator 506 may access the corresponding user profiles and update these corresponding user profiles to denote that these users are vegan.

It should be noted that the components of the profile attribute generator 506 continuously, and in real-time, process attributes corresponding to different users and family profiles to continuously update and refine the user profiles 110 associated with the users and the family profile 106. This may ensure that the user profiles accurately convey the unique attributes of each user within the family profile. Further, this may ensure that the relationships between these users as defined through these user profiles 110 closely mirror the unique dynamics of the family profile. This may allow the wellness system 102, through the aforementioned automated agents, to better communicate with the different users according to their unique attributes and according to the identified dynamics of the family profile.

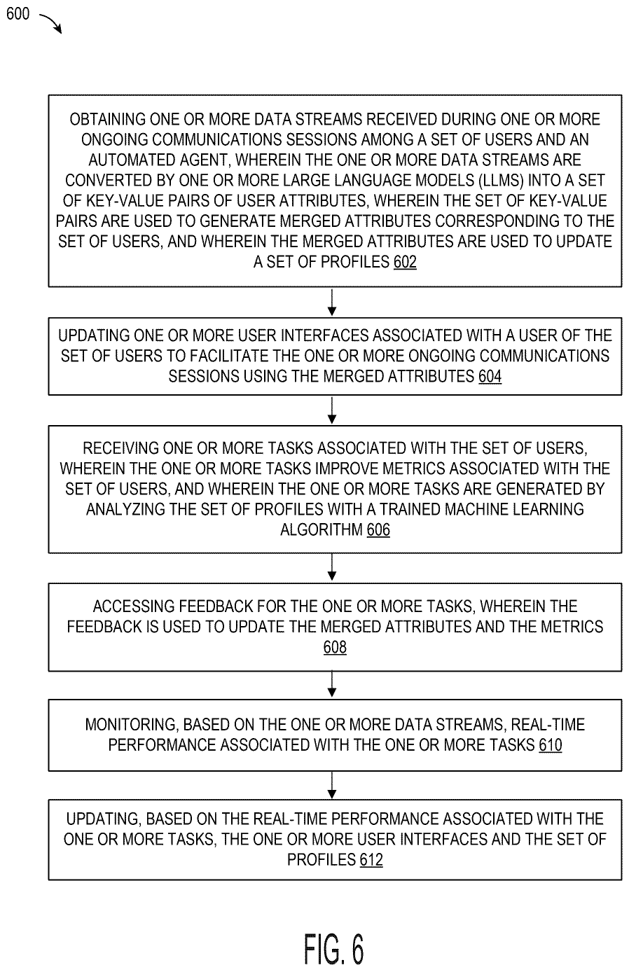

FIG. 6 is a flowchart depicting an exemplary process 600 for using artificial intelligence systems to provide services to user systems, in accordance with various embodiments. Process 600 may be performed by the systems of FIGS. 1-5 and 14 and their various components. At block 602, process 600 involves obtaining one or more data streams received during one or more ongoing communications sessions among a set of users and an automated agent, wherein the one or more data streams are converted by one or more large language models (LLMs) into a set of key-value pairs of user attributes, wherein the set of key-value pairs are used to generate merged attributes corresponding to the set of users, and wherein the merged attributes are used to update a set of profiles. Examples of data streams are illustrated with respect to FIGS. 2 and 3.

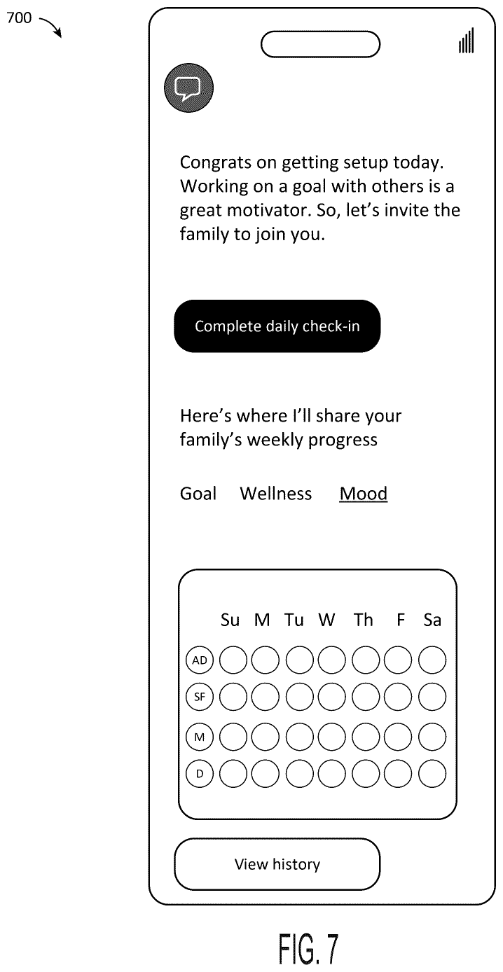

At block 604, process 600 involves updating one or more user interfaces associated with a user of the set of users to facilitate the one or more ongoing communications sessions using the merged attributes. As discussed below, FIGS. 7-13 describe various user interfaces, any of which may be updated at block 604.

At block 606, process 600 involves receiving one or more tasks associated with the set of users, wherein the one or more tasks improve metrics associated with the set of users, and wherein the one or more tasks are generated by analyzing the set of profiles with a trained machine learning algorithm.

At block 608, process 600 involves accessing feedback for the one or more tasks, wherein the feedback is used to update the merged attributes and the metrics.

At block 610, process 600 involves monitoring, based on the one or more data streams, real-time performance associated with the one or more tasks.

At block 612, process 600 involves updating, based on the real-time performance associated with the one or more tasks, the one or more user interfaces and the set of profiles. Any of the interfaces described with respect to FIGS. 7-13 may be updated at block 612.

FIG. 7 illustrates an example user interface 700 for example application 140a presenting the family's weekly progress toward a wellness goal. In some examples, the user interface 700 may provide summaries of ongoing collective progress, facilitate daily engagement via the application, and/or provide messages to related users, such as encouraging words or motivating phrases. For example, user interface 700 congratulates the user on getting set up and encourages working on a goal together with family members. In some examples, the user interface 700 provides options to complete a daily check-in, a section including various categories, such as “Goal,” “Wellness,” and “Mood,” and/or a day-of-week selector (Su M Tu W Th F Sa) indicating check-in or progress status across a week. In some examples, user avatars or initials may be included (e.g., AD, SF, M, D) representing different users comprising the family. In some examples, an option to “View history,” may be provided to access past data or check-ins. The general purpose of this figure is to summarize ongoing collective progress and facilitate daily engagement in the wellness goal.

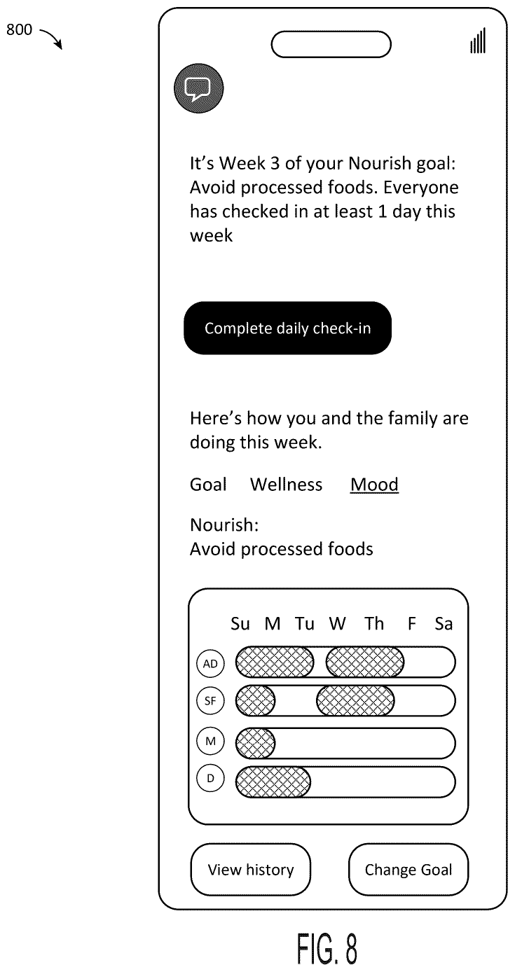

FIG. 8 illustrates an example user interface 800 for example application 140a including a detailed status update related to the example user interface of FIG. 7. In some examples, the user interface 800 may include a detailed status for the current week (e.g., “Week 3 of your Nourish goal: Avoid processed foods.”). The user interface 800 may provide a status message regarding check-ins for the individual family members. For example, text in the user interface 800 mentions that all family members have checked in at least once during the week, reinforcing the importance of goal tracking and working towards a common goal. In some examples, option such as, “View history,” and “Change Goal” may be included in order to allow users modify their focus.

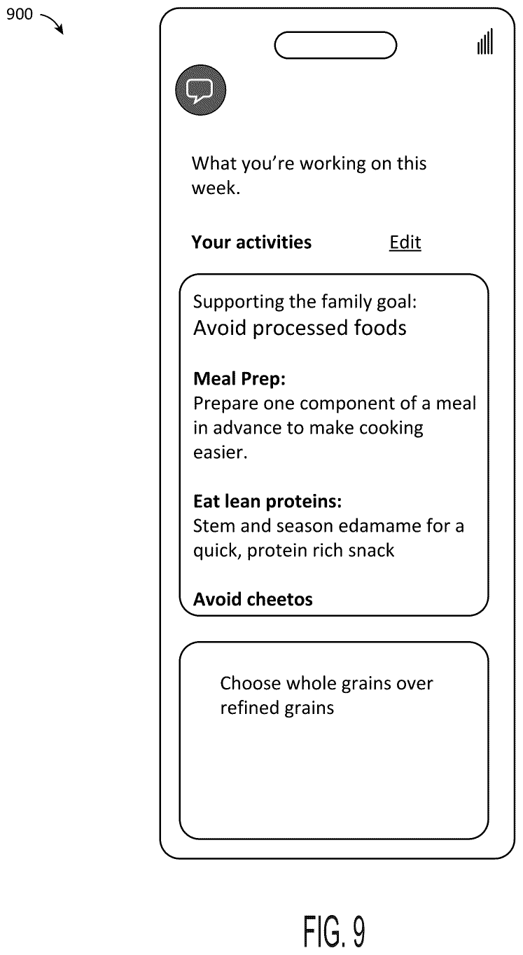

FIG. 9 illustrates an example user interface 900 for example application 140a including a summary of the week for a user. The user interface 900 may provide, for example, a header indicating the summary of the week for the particular user, such as, “What you're working on this week” with reference to activities supporting the family goal to “Avoid processed foods.” In some examples, the user may edit the activities by using the “Edit” button or hyperlink. Activity items may be listed, such as “Meal Prep: Prepare one component of a meal in advance to make cooking easier,” “Eat lean proteins,” “Stem and season edamame for a quick, protein rich snack,” “Avoid cheetos,” and “Choose whole grains over refined grains.” In some examples, the user interface 900 screen provides a user interface for individuals or family members to track and modify actionable steps they are taking toward the overarching goal, offering both guidance and customization for activity management.

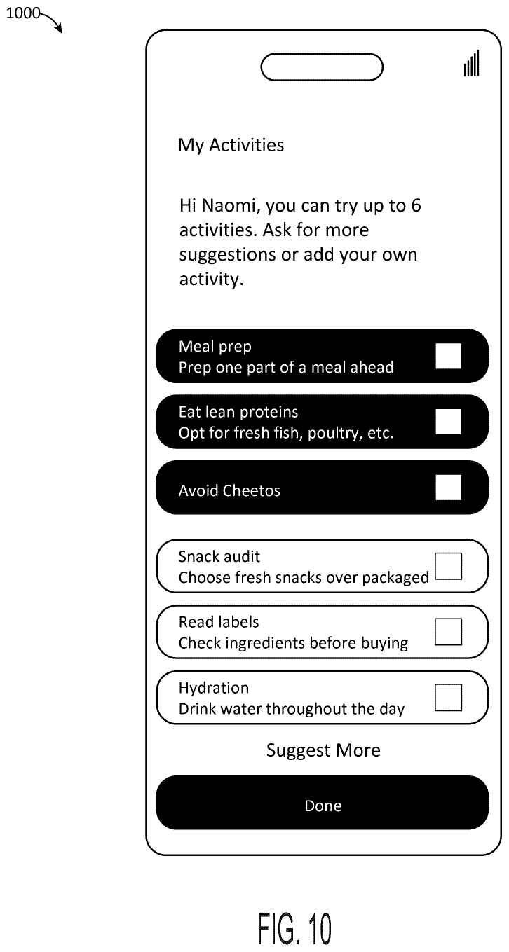

FIG. 10 illustrates an example user interface 1000 for example application 140a providing activities for a user. As a non-limiting example, user interface 1000 may include a header, such as “My Activities” and may be customized to the user (e.g., “Naomi”). The user interface 1000 provides example activities that the user may check off to allow her to try up to six activities. The user interface 1000 may also offer the possibility to ask for more suggestions or add custom activities. The example list includes “Meal prep. Prep one part of a meal ahead”, “Eat lean proteins. Opt for fresh fish, poultry, etc.”, “Avoid Cheetos,” “Snack audit. Choose fresh snacks over packaged,” “Read labels. Check ingredients before buying,” and “Hydration. Drink water throughout the day.” The user interface 1000 offers options to “Suggest More” and mark choices as “Done.” As illustrated, the wellness system 102 may provide personalized activity selection and engagement within the broader family goal framework via user interfaces, such as user interface 1000.

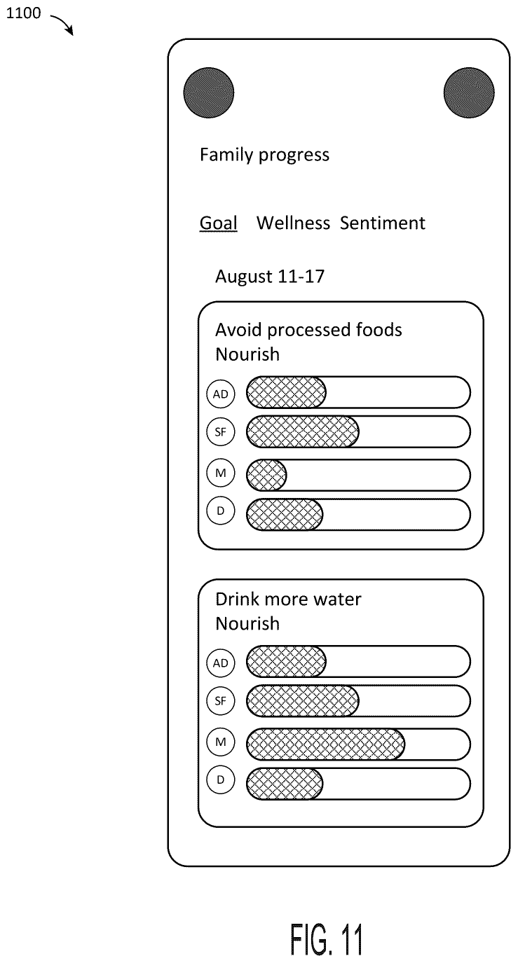

FIG. 11 illustrates an example user interface 1100 for example application 140a providing a family progress summary for multiple goals across a defined week (e.g., August 11-17). As a non-limiting example, the screen contains columns or rows for two goals: “Avoid processed foods. Nourish” and “Drink more water. Nourish.” In some examples, each goal lists initials (e.g., AD, SF, M, D) representing participation or completion status for each family member. Different categories may be displayed depending on user and/or family goals. For example, categories across the top of the user interface 1100 include “Goal,” “Wellness,” and “Sentiment,” which represent tracking of the categories for the family, and for individuals in the family. In some examples, the user interface 1100 functions as an at-a-glance progress board for family wellness initiatives for a defined period of time (e.g., a week, a month, several months, a year, or another customized time entered by the user, etc.).

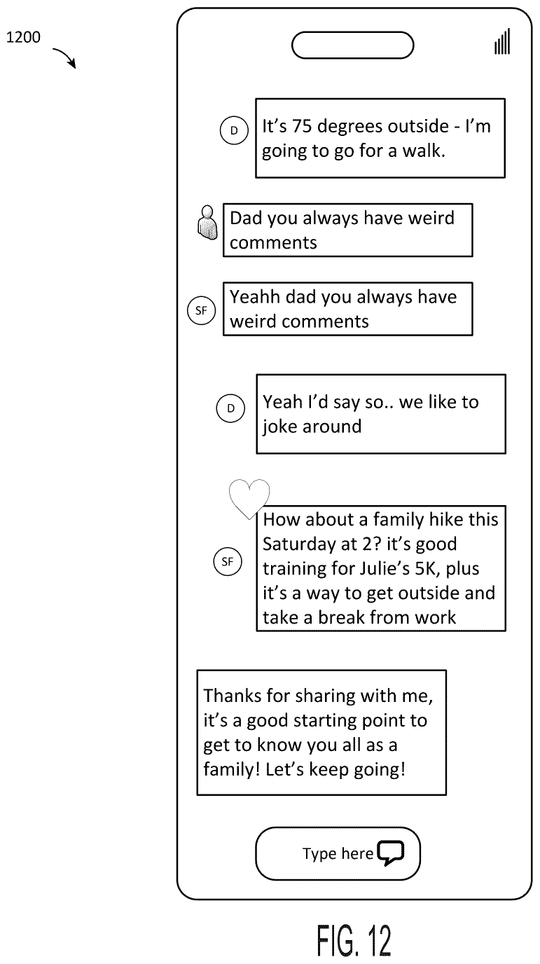

FIG. 12 illustrates an example chat user interface 1200 for example application 140a depicting an example conversation among users and an agent AI 104. In some examples, the agent AI 104 extracts information from the conversation as described above, converts the extracted information, and then uses the converted information to generate or update family and user profiles. In the example chat user interface 1100, the conversation includes family banter (“Yeahh dad you always have weird questions”), a discussion about going for a walk, a suggestion for a family hike (with timing for Julie's 5K training), and prompts encouraging continued engagement from the agent AI 104 in response to the comments from the users (“Thanks for sharing with me, it's a good starting point to get to know you all as a family! Let's keep going”). In some examples, chat interfaces or group messaging features within the wellness system 102 foster family discussion and goal-related planning.

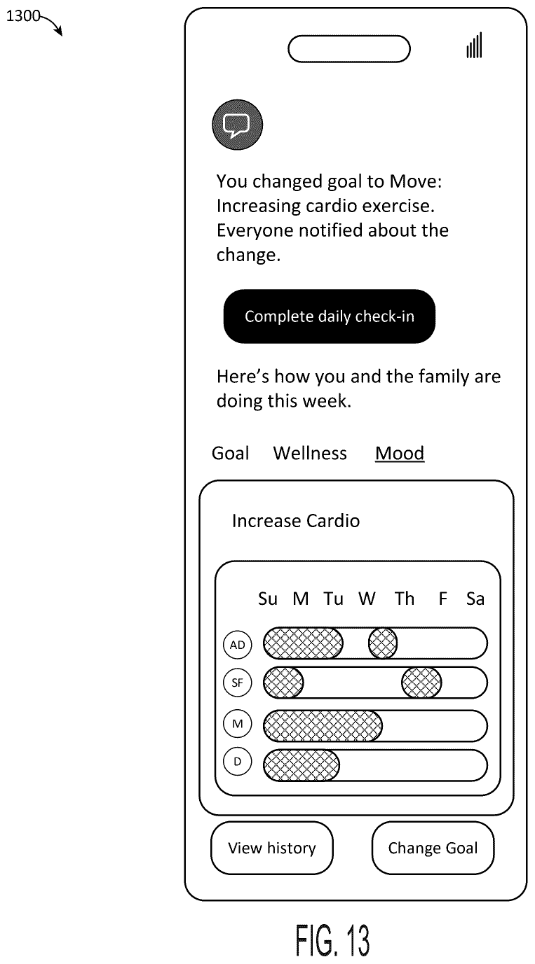

FIG. 13 illustrates an example user interface 1300 for example application 140a including a confirmation of a change in one or more goals by a user. In some examples, the user interface 1300 may provide the user with a confirmation of the goal change and/or an indication that the other family members will be notified (e.g., “You changed goal to Move: Increasing cardio exercise. Everyone notified about the change.”). The user interface 1300 may prompt a daily check-in, report how the family is doing for the new week, and provide status for categories such as goals, wellness and mood, as non-limiting examples. In some examples, the user interface 1300 provides a specific active goal, such as “Increase Cardio.” A day-of-week progress tracker, as well as progress for family members (e.g., family members with initials AD, SF, M, D) may be provided. In some examples, additional options, such as “View history”, “Change Goal,” etc., may be provided.

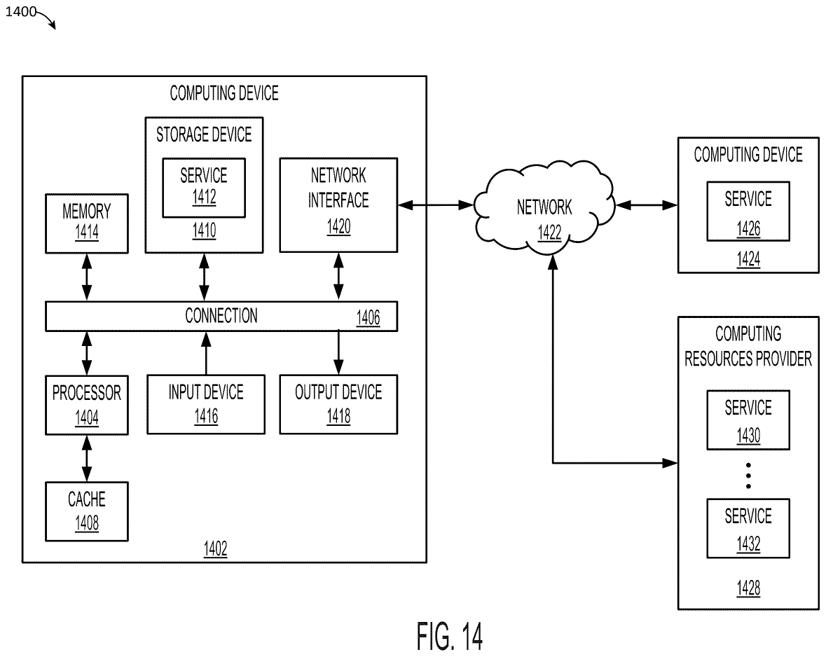

FIG. 14 illustrates a computing system architecture 1400, including various components in electrical communication with each other, in accordance with some embodiments. The example computing system architecture 1400 illustrated in FIG. 14 includes a computing device 1402, which has various components in electrical communication with each other using a connection 1406, such as a bus, in accordance with some implementations. The example computing system architecture 1400 includes a processor 1404 that is in electrical communication with various system components, using the connection 1406, and including the system memory 1414. In some embodiments, the system memory 1414 includes read-only memory (ROM), random-access memory (RAM), and other such memory technologies including, but not limited to, those described herein. In some embodiments, the example computing system architecture 1400 includes a cache 1408 of high-speed memory connected directly with, in close proximity to, or integrated as part of the processor 1404. The system architecture 1400 can copy data from the memory 1414 and/or the storage device 1410 to the cache 1408 for quick access by the processor 1404. In this way, the cache 1408 can provide a performance boost that decreases or eliminates processor delays in the processor 1404 due to waiting for data. Using modules, methods and services such as those described herein, the processor 1404 can be configured to perform various actions. In some embodiments, the cache 1408 may include multiple types of cache including, for example, level one (L1) and level two (L2) cache. The memory 1414 may be referred to herein as system memory or computer system memory. The memory 1414 may include, at various times, elements of an operating system, one or more applications, data associated with the operating system or the one or more applications, or other such data associated with the computing device 1402.

Other system memory 1414 can be available for use as well. The memory 1414 can include multiple different types of memory with different performance characteristics. The processor 1404 can include any general purpose processor and one or more hardware or software services, such as service 1412 stored in storage device 1410, configured to control the processor 1404 as well as a special-purpose processor where software instructions are incorporated into the actual processor design. The processor 1404 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 1404 can be a microprocessor, a microcontroller, a digital signal processor (“DSP”), or a combination of these and/or other types of processors. In some embodiments, the processor 1404 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 1400, an input device 1416 can represent any number of input mechanisms, such as a microphone for speech, a touch-sensitive screen for gesture or graphical input, keyboard, mouse, motion input, pen, and other such input devices. An output device 1418 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 1400. In some embodiments, the input device 1416 and/or the output device 1418 can be coupled to the computing device 1402 using a remote connection device such as, for example, a communication interface such as the network interface 1420 described herein. In such embodiments, the communication interface can govern and manage the input and output received from the attached input device 1416 and/or output device 1418. As may be contemplated, there is no restriction on operating on any particular hardware arrangement and accordingly the basic features here may easily be substituted for other hardware, software, or firmware arrangements as they are developed.

In some embodiments, the storage device 1410 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 1410 can include hardware and/or software services such as service 1412 that can control or configure the processor 1404 to perform one or more functions including, but not limited to, the methods, processes, functions, systems, and services described herein in various embodiments. In some embodiments, the hardware or software services can be implemented as modules. As illustrated in example computing system architecture 1400, the storage device 1410 can be connected to other parts of the computing device 1402 using the system connection 1406. In an embodiment, a hardware service or hardware module such as service 1412, that performs a function can include a software component stored in a non-transitory computer-readable medium that, in connection with the necessary hardware components, such as the processor 1404, connection 1406, cache 1408, storage device 1410, memory 1414, input device 1416, output device 1418, and so forth, can carry out the functions such as those described herein.

The disclosed processed for generating and executing experience recommendations can be performed using a computing system such as the example computing system illustrated in FIG. 14, using one or more components of the example computing system architecture 1400. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and functions for generating and executing experience recommendations described herein by, for example, executing code using a processor such as processor 1404 wherein the code is stored in memory such as memory 1414 as described herein. One or more of a user device, a provider server or system, a database system, or other such devices, services, or systems may include some or all of the components of the computing system such as the example computing system illustrated in FIG. 14, using one or more components of the example computing system architecture 1400 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 1428. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 1404 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 1414 can be coupled to the processor 1404 by, for example, a connector such as connection 1406, or a bus. As used herein, a connector or bus such as connection 1406 is a communications system that transfers data between components within the computing device 1402 and may, in some embodiments, be used to transfer data between computing devices. The connection 1406 can be a data bus, a memory bus, a system bus, or other such data transfer mechanism. Examples of such connectors include, but are not limited to, an industry standard architecture (“ISA” bus, an extended ISA (EISA) bus, a parallel AT attachment (“PATA” bus (e.g., an integrated drive electronics (IDE) or an extended IDE (EIDE) bus), or the various types of parallel component interconnect (PCI) buses (e.g., PCI, PCIe, PCI-104, etc.).

The memory 1414 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 1414 can also include magnetic or optical data storage media including read-only (e.g., CD ROM and DVD ROM) or otherwise (e.g., CD or DVD). The memory can be local, remote, or distributed.

As described above, the connection 1406 (or bus) can also couple the processor 1404 to the storage device 1410, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data is may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 1410. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 1406 can also couple the processor 1404 to a network interface device such as the network interface 1420. The interface can include one or more of a modem or other such network interfaces including, but not limited to those described herein. It will be appreciated that the network interface 1420 may be considered to be part of the computing device 1402 or may be separate from the computing device 1402. The network interface 1420 can include one or more of an analog modem, Integrated Services Digital Network (ISDN) modem, cable modem, token ring interface, satellite transmission interface, or other interfaces for coupling a computer system to other computer systems. In some embodiments, the network interface 1420 can include one or more input and/or output (I/O) devices. The I/O devices can include, by way of example but not limitation, input devices such as input device 1416 and/or output devices such as output device 1418. For example, the network interface 1420 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 1402 can be connected to one or more additional computing devices such as computing device 1424 via a network 1422 using a connection such as the network interface 1420. In such embodiments, the computing device 1424 may execute one or more services 1426 to perform one or more functions under the control of, or on behalf of, programs and/or services operating on computing device 1402. In some embodiments, a computing device such as computing device 1424 may include one or more of the types of components as described in connection with computing device 1402 including, but not limited to, a processor such as processor 1404, a connection such as connection 1406, a cache such as cache 1408, a storage device such as storage device 1410, memory such as memory 1414, an input device such as input device 1416, and an output device such as output device 1418. In such embodiments, the computing device 1424 can carry out the functions such as those described herein in connection with computing device 1402. In some embodiments, the computing device 1402 can be connected to a plurality of computing devices such as computing device 1424, each of which may also be connected to a plurality of computing devices such as computing device 1424. Such an embodiment may be referred to herein as a distributed computing environment.

The network 1422 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 1422 can be wired connections, wireless connections, or combinations thereof. Communications via the network 1422 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 1422, within the computing device 1402, within the computing device 1424, or within the computing resources provider 1428 can include information, which also may be referred to herein as content. The information may include text, graphics, audio, video, haptics, and/or any other information that can be provided to a user of the computing device such as the computing device 1402. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 1402 and presented to a user of the computing device 1402 using forms that are perceptible via sight, sound, smell, taste, touch, or other such mechanisms. In some embodiments, communications over the network 1422 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 1402 and/or the computing device 1424 can be connected to a computing resources provider 1428 via the network 1422 using a network interface such as those described herein (e.g. network interface 1420). In such embodiments, one or more systems (e.g., service 1430 and service 1432) hosted within the computing resources provider 1428 (also referred to herein as within “a computing resources provider environment”) may execute one or more services to perform one or more functions under the control of, or on behalf of, programs and/or services operating on computing device 1402 and/or computing device 1424. Systems such as service 1430 and service 1432 may include one or more computing devices such as those described herein to execute computer code to perform the one or more functions under the control of, or on behalf of, programs and/or services operating on computing device 1402 and/or computing device 1424.

For example, the computing resources provider 1428 may provide a service, operating on service 1430 to store data for the computing device 1402 when, for example, the amount of data that the computing device 1402 exceeds the capacity of storage device 1410. In another example, the computing resources provider 1428 may provide a service to first instantiate a virtual machine (VM) on service 1432, use that VM to access the data stored on service 1432, perform one or more operations on that data, and provide a result of those one or more operations to the computing device 1402. Such operations (e.g., data storage and VM instantiation) may be referred to herein as operating “in the cloud,” “within a cloud computing environment,” or “within a hosted virtual machine environment,” and the computing resources provider 1428 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 1428 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 1430 and service 1432 may implement versions of various services (e.g., the service 1412 or the service 1426) on behalf of, or under the control of, computing device 1402 and/or computing device 1424. Such implemented versions of various services may involve one or more virtualization techniques so that, for example, it may appear to a user of computing device 1402 that the service 1412 is executing on the computing device 1402 when the service is executing on, for example, service 1430. As may also be contemplated, the various services operating within the computing resources provider 1428 environment may be distributed among various systems within the environment as well as partially distributed onto computing device 1424 and/or computing device 1402.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 1402) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram. Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 1402.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method, the method comprising:
obtaining one or more data streams received during one or more ongoing communications sessions among a set of users and an automated agent, wherein the one or more data streams are converted by one or more large language models (LLMs) into a set of key-value pairs of user attributes, wherein the set of key-value pairs are used to generate merged attributes corresponding to the set of users, and wherein the merged attributes are used to update a set of profiles;
updating one or more user interfaces associated with a user of the set of users to facilitate the one or more ongoing communications sessions using the merged attributes;
receiving one or more tasks associated with the set of users, wherein the one or more tasks improve metrics associated with the set of users, and wherein the one or more tasks are generated by analyzing the set of profiles with a trained machine learning algorithm;
accessing feedback for the one or more tasks, wherein the feedback is used to update the merged attributes and the metrics;
monitoring, based on the one or more data streams, real-time performance associated with the one or more tasks; and
updating, based on the real-time performance associated with the one or more tasks, the one or more user interfaces and the set of profiles.

2. The computer-implemented method of claim 1, further comprising: dynamically performing one or more actions to improve performance for the one or more tasks, wherein the one or more actions are performed based on the merged attributes.

3. The computer-implemented method of claim 1, wherein the one or more data streams includes data from one or more wearable devices, an application, or a tablet.

4. The computer-implemented method of claim 1, wherein the one or more data streams includes data received from a microphone or camera associated with one or more users from the set of users.

5. The computer-implemented method of claim 1, further comprising updating a knowledge graph and a vector store using the user attributes.

6. The computer-implemented method of claim 1, wherein the one or more data streams include a user input corresponding to a particular topic of interest to the user of the set of users.

7. The computer-implemented method of claim 1, further comprising:
receiving additional communications sessions based on a new set of goals.

8. The computer-implemented method of claim 1, further comprising:
presenting, via the one or more user interfaces, a suggested new task based on the merged attributes, and one or more options for completing the suggested new task.

9. The computer-implemented method of claim 8, wherein the suggested new task is a time-based task.

10. The computer-implemented method of claim 1, further comprising:
presenting, via the one or more user interfaces, a request associated with the merged attributes.

11. The computer-implemented method of claim 1, further comprising:
continuously monitoring the one or more ongoing communications sessions to detect changes in the user attributes; and
updating the one or more user interfaces with suggestions based on the changes.

12. The computer-implemented method of claim 11, wherein the suggestions include updating at least one of a user profile, a user task, or a goal for the set of users.

13. The computer-implemented method of claim 11, wherein at least one of a policy or a permission is updated for a user device or set of user devices based on the changes.

14. A system, comprising:
one or more processors; and
memory storing thereon instructions that, as a result of being executed by the one or more processors, cause the system to:
obtain one or more data streams received during one or more ongoing communications sessions among a set of users and an automated agent, wherein the one or more data streams are converted by one or more large language models (LLMs) into a set of key-value pairs of user attributes, wherein the set of key-value pairs are used to generate merged attributes corresponding to the set of users, and wherein the merged attributes are used to update a set of profiles;
update one or more user interfaces associated with a user of the set of users to facilitate the one or more ongoing communications sessions using the merged attributes;
receive one or more tasks associated with the set of users, wherein the one or more tasks improve metrics associated with the set of users, and wherein the one or more tasks are generated by analyzing the set of profiles with a trained machine learning algorithm;
access feedback for the one or more tasks, wherein the feedback is used to update the merged attributes and the metrics;
monitor, based on the one or more data streams, real-time performance associated with the one or more tasks; and
update, based on the real-time performance associated with the one or more tasks, the one or more user interfaces and the set of profiles.

15. The system of claim 14, wherein the instructions further cause the system to:
dynamically perform one or more actions to improve performance for the one or more tasks, wherein the one or more actions are performed based on the merged attributes.

16. The system of claim 14, wherein the instructions further cause the system to:
continuously monitor the one or more ongoing communications sessions to detect changes in the user attributes; and
update the one or more user interfaces with suggestions based on the changes.

17. The system of claim 14, wherein the instructions further cause the system to:
receive additional communications sessions based on a new set of goals.

18. The system of claim 14, wherein the instructions further cause the system to:
present, via the one or more user interfaces, a suggested new task based on the merged attributes, and one or more options for completing the suggested new task.

19. A non-transitory computer-readable storage medium storing thereon executable instructions that, as a result of being executed by one or more processors of a computer system, cause the computer system to:
obtain one or more data streams received during one or more ongoing communications sessions among a set of users and an automated agent, wherein the one or more data streams are converted by one or more large language models (LLMs) into a set of key-value pairs of user attributes, wherein the set of key-value pairs are used to generate merged attributes corresponding to the set of users, and wherein the merged attributes are used to update a set of profiles;
update one or more user interfaces associated with a user of the set of users to facilitate the one or more ongoing communications sessions using the merged attributes;
receive one or more tasks associated with the set of users, wherein the one or more tasks improve metrics associated with the set of users, and wherein the one or more tasks are generated by analyzing the set of profiles with a trained machine learning algorithm;
access feedback for the one or more tasks, wherein the feedback is used to update the merged attributes and the metrics;
monitor, based on the one or more data streams, real-time performance associated with the one or more tasks; and
update, based on the real-time performance associated with the one or more tasks, the one or more user interfaces and the set of profiles.

20. The non-transitory computer-readable storage medium of claim 19, wherein the executable instructions further cause the computer system to:
dynamically perform one or more actions to improve performance for the one or more tasks, wherein the one or more actions are performed based on the merged attributes.
